(19) United States
(12) Patent Application Publication
(10) Pub. No.: US 2002/0103865 A1
(43) Pub. Date: Aug. 1, 2002

(54) Logbook database system

(76) Inventor: Robin Lilly, Las Cruces, NM (US)

Correspondence Address: STONEMAN LAW OFFICES, LTD, 3113 NORTH 3RD STREET, PHOENIX, AZ, 85012, US

(21) Appl. No.: 10/062,013

(22) Filed: Jan. 31, 2002

Related U.S. Application Data
(60) Provisional application No. 60/265,691, filed on Feb. 1, 2001.
(60) Provisional application No. 60/284,483, filed on Apr. 18, 2001.
(60) Provisional application No. 60/344,697, filed on Dec. 24, 2001.

(51) Int. Cl. G06F 15/16

(52) U.S. Cl. 709/205; 709/218

(57) ABSTRACT

A method and system for recording the actions and activities (as for a logbook) of a person, persons, machines, or other animate or inanimate objects using portable or stationary devices. These devices are (1) directly connected, or wired, or (2) are connected wirelessly to a local (LAN) or wide area network (WAN). The actions or activity are either immediately transmitted to the local or wide area network and received and recorded on a server system, or recorded and held in the wired/wireless device and then transmitted to the server system at a later date. Once recorded on the server system, the actions and activities are accessible to wired or wireless devices via local or wide area networks or available to other server systems. They can be reviewed and acknowledged by an authoritative entity through the use of an electronic signature facility.

### CROSS-REFERENCES TO RELATED APPLICATIONS

The present application is related to applicant's prior U.S. Provisional Application No. 60/265,691, filed Feb. 1, 2001, entitled “LOGBOOK DATABASE SYSTEM”, and is related to U.S. Provisional Application No. 60/284,483, filed Apr. 18, 2001, entitled “LOGBOOK DATABASE SYSTEM”, and is related to and U.S. Provisional Application No. 60/344,697, entitled “LOGBOOK DATABASE METHOD AND SYSTEM”, filed Dec. 24, 2001, the contents of all of which are hereby herein incorporated by reference and are not admitted to be prior art with respect to the present invention by their mention in this cross-reference section.

### BACKGROUND

The present invention relates generally to an electronic logbook used for recording and displaying actions and activities and, more specifically, to a system in which actions and activities are recorded, assigned to an individual, and reviewed or approved by authoritative entities through the use of electronic signatures.

For many years, recording personal activities required the use of a pen or pencil and a hardcopy medium like ledgers, calendars and/or purposely-designed paper “logs.” Each activity was hand-written, recorded, and not easily modifiable. When a record of activities required a review or approval by a supervisor or some other authoritative entity, the hardcopy log had to be “handed off” to the authority wherein it was then reviewed and signed, verifying that the record had indeed been reviewed.

As technology improved, new devices became available for logging activities. These included the audio or tape recorders on which a person wishing to make a record of an activity would verbally describe the activity and record it on a magnetic medium, such as audio recording tape. While these devices worked well for creating an audio recording of the activities, they did not allow for easy review or modification, and more specifically, did not allow for an authoritative entity to approve or review the record of the activity. There was simply no facility for “signing off” on the recorded activity. As a result, the activities had to be transcribed into a hardcopy medium and then reviewed.

With the proliferation of the personal computer, individuals began using word processing software to develop their own activity logs, or using other software more specifically designed for recording activities. The advantage the personal computer afforded was that the log of the activities could easily be modified and then printed. Once printed, the log could be reviewed by an authoritative entity. The disadvantage was that the paper copy had to be kept as the reviewed and official copy of the log.

Recently, a wide range of interactive devices has been developed to provide information to a variety of users via communications networks. These interactive devices include, for example, computers connected to various computer on-line services, interactive kiosks, interactive television systems, a variety of other wired and wireless devices, such as personal digital assistants (PDA's ), and the like. In particular, the popularity of computer on-line services has grown immensely in popularity over the last decade. Computer on-line services are provided by a wide variety of different companies.

In general, most computer on-line services are accessed via the Internet. The Internet is a global network of computers. One popular part of the Internet is the World Wide Web, or the “Web.” The World Wide Web contains computers that display graphical and textual information. Computers that provide information on the World Wide Web are typically called “Web sites.” A Web site is defined by an Internet address that has an associated electronic page, often called a “home page.” Generally, a home page is an electronic document that organizes the presentation of text, graphical images, audio and video into a desired display. These Web sites are operated by a wide variety of entities, which are typically called “providers.”

A user may access the Internet via a dedicated high-speed line or by using a personal computer (PC) equipped with a conventional modem or a variety of other wired and wireless devices. Special interface software, called “browser” software, is installed within the PC or other access device. When the user wishes to access the Internet by normal telephone line, an attached modem is automatically instructed to dial the telephone number associated with the local Internet host server. The user can then access information at any address accessible over the Internet. Two well-known web browsers, for example, are the Netscape Navigator browser marketed by Netscape Communications Corporation and the Internet Explorer browser marketed by Microsoft Corporation.

Information exchanged over the Internet is typically encoded in Hypertext Mark-up Language (HTML) format. The HTML format is a scripting language that is used to generate the home pages for different content providers. In this setting, a content provider is an individual or company that places information (content) on the Internet so that others can access it. As is well known in the art, the HTML format is a set of conventions for marking different portions of a document so that each portion appears in a distinctive format. For example, the HTML format identifies or “tags” portions of a document to identify different categories of text (e.g., the title, header, body text, etc.). When a web browser accesses an HTML document, the web browser reads the embedded tags in the document so it appears formatted in the specified manner.

An HTML document can also include hyperlinks, which allow a user to move from one document to another document on the Internet. A hyperlink is an underlined or otherwise emphasized portion of text that, when selected using an input device such as a mouse, activates a software connection module that allows the user to jump between documents or pages (i.e., within the same Web site or to other Web sites). Hyperlinks are well known in the art, and have been sometimes referred to as anchors. The act of selecting the hyperlink is often referred to as “clicking on” the hyperlink.

Today, in spite of the advent of the Internet, most, if not all, of logbook information is maintained in hardcopy form or in scattered and unrelated databases. Many regulatory requirements now require rapid and centralized access to detailed information, for example, on pilots' background, training status, flight history, medical background, as well specific identification characteristics such as fingerprints, retinal scans and pictures. Because of this “dispersal” of information about, for example, pilots across many locations and in differing formats, it is not all available for searching and analysis by any one of the several regulatory and enforcement agencies. This example lack of centralized access to pilots' background, certifications, certification status, flight history and medical background impacts both employers and regulatory authorities.

In addition, some of this required information is today the responsibility of one or more of various private and public authorities, making it difficult to share the information between many of these private and public authorities when appropriate. An example of this problem is the inability to report to employers and regulatory authorities an individual pilot's compliance status with many of the FAA mandated requirements. Pilots themselves must maintain their own “tickler system” to ensure they comply with the FAA regulations in a timely manner. Further, each of the public authorities has differing objectives and requirements that are difficult to reconcile or meet within the current framework.

Finally, because of these shortcomings, regulatory and enforcement entities have been inconsistent and slow in managing and enforcing the regulations, particularly for non-airline pilots. These and related problems have recently become even more a subject of national and international needs in security areas, etc. Thus, it would be an advantageous object and feature to provide an Internet method of doing business that would provide authoritative entities (like the F.A.A.) a national or international unified and searchable database of logbook information (as for pilots) which information could also be associated with security information (like identification information).

The advent and subsequent increased use of the Internet and its interconnected communications systems, coupled with new wireless technology and hand-held devices, like the personal digital assistant, have provided an opportunity for the development of new and advanced methods of activity logging.

A new logbook system should be accessible from Internet-connected personal computers, or wireless PDA's, allowing worldwide wired and wireless, stationary and portable logging capabilities. In addition, the system should provide the necessary hardcopy printing and reporting capabilities while offering a new electronic authoritative review and signature facility and improved access by regulatory and other appropriate authorities.

### OBJECTS OF THE INVENTION

It is a primary object and feature of this invention to fill the above-mentioned needs. It is a further object and feature to provide a method and system for recording actions or activities in an electronic logbook, which logbook can be reviewed or approved by an authoritative entity that applies an electronic signature to the record, so that the electronic signature may then become part of the record. It is a further object and feature of this invention to provide a method and system for facilitating review by an authoritative entity for endorsement of a user's recorded actions by applying an electronic signature to the record, so that the electronic signature may then become part of the record.

Also, it is an object and feature of this invention to provide such a system that is efficient, economical, and trustworthy.

It is a further object and feature to provide the facility for recording and storing necessary information about pilots (and some other regulated logbook users) to facilitate searching the database on a wide variety of criteria. Also, it is an object and feature of this invention to provide a unified method and system by which one or more authoritative entities might have responsibility for maintenance of a portion of information about each pilot stored in the database.

Further, it is an object and feature of this invention to provide a method and system for alerting authoritative entities and individuals regarding compliance with employer and regulatory requirements.

A further object and feature of this invention is to allow authoritative entities to review, query and create reports of data contained in the system.

Still further, it is an object and feature of this invention to provide a method and system for inputting checklist completion information for later retrieval and analysis.

A further object and feature of this invention is to provide a mechanism that allows the functionality of the logbook system to be distributed via the Internet, a WAN or a LAN and allow users of the system to build a personalized interface to the system to meet their particular needs.

Yet another object and feature of this invention is to provide an Internet-served method of doing business that accomplishes the unification of the various other objects and features herein mentioned, and many others.

### SUMMARY OF THE INVENTION

According to a preferred embodiment of the present invention, this invention provides an Internet system, for the unified collection of required logbook information, comprising the steps of: permitting substantially all users of at least one population of such users in at least one specified regulated area of at least one specified geo-political area, from respective user-input stations, to input respective data packets relating to such required logbook information to at least one Internet server; and storing of such inputted required logbook information in at least one unified database system. It also provides such a system further comprising permitting at least one authoritative entity, related to such at least one specified regulated area of such at least one specified geopolitical area, at least partial access to such stored required logbook information.

Moreover, this invention provides such a system further comprising permitting at least one authoritative entity, related to such at least one specified regulated area of such at least one specified geo-political area, at least partial access to such stored required logbook information. And it provides such a system further comprising: permitting storing in such at least one unified database of at least one requirement for compliance set by such at least one authoritative entity for such at least one user; and defining which such at least one authoritative entity is responsible for such setting at least one requirement for compliance for such at least one user.

It also provides such a system further comprising: identifying potential impending non-compliance with such at least one requirement for compliance by such at least one user; notifying such at least one user of such impending non-compliance with such at least one requirement for compliance; and notifying such at least one authoritative entity of such impending non-compliance with such at least one requirement for compliance for such at least one user. Moreover it provides such a system comprising the step of selectively authorizing such at least one authoritative entity to search such logbook information relating to impending non-compliance. In addition, it provides such a system further comprising: identifying non-compliance with such at least one requirement for compliance by such at least one user; notifying such at least one user of such non-compliance with such at least one requirement for compliance; and notifying at least authoritative entity of such non-compliance with such at least one requirement for compliance for such at least one user. It also provides such a system further comprising the steps of selectively authorizing such at least one authoritative entity to search such logbook information relating to at least such non-compliance.

In addition, this invention provides such a system further comprising: permitting requesting at least one electronic authorization signature from such at least one authoritative entity relating to such logbook information of such at least one user by such at least one user; permitting inputting such at least one electronic authorization signature relating to such logbook information of such at least one user by such at least one authoritative entity; and storing in such unified database system such at least one electronic authorization signature relating to such logbook information of such at least one user.

Moreover, it provides a system further comprising: permitting requesting at least one electronic endorsement signature from such at least one authoritative entity relating to such logbook information of such at least one user by such at least one user; permitting inputting such at least one electronic endorsement signature by such at least one authoritative entity relating to such logbook information of such at least one user; and storing in such unified database system such at least one electronic endorsement signature relating to such logbook information of such at least one user.

Moreover, this invention provides such a system further comprising: permitting selective authorization, by such at least one authoritative entity, for such at least one user, from respective client stations, to send selective information relating to such logbook information to such at least one Internet server; and permitting access by such at least one user to such selective information. In addition, it provides such a system further comprising: permitting such at least one user to select at least one search criterion for the selection of information; and permitting such at least one user to view such information that meets such at least one criterion. And it provides such a system further comprising permitting embedding of such logbook information directly into other electronic documents where all combined document details, both those from such logbook information and such other original documents, can be analyzed.

Moreover, it provides such a system further comprising: permitting such at least one user, from respective user-input stations, to send respective data packets relating to respective demographic information to an Internet server; and storing in such unified database system such demographic information relating to such logbook information of such at least one user. And it provides such a system further comprising: permitting such at least one authoritative entity, from respective client stations, to send respective data packets relating to respective biomedical identification information for such at least one user to such at least one Internet server; and storing in such unified database system such biomedical identification information relating to such logbook information of such at least one user. It also provides such a system further comprising: permitting such at least one authoritative entity, from respective client stations, to send respective data packets relating to respective medical information for such at least one user to such at least one Internet server; and storing in such unified database system such medical information relating to such logbook information of such at least one user. And it provides such a system further comprising implementing accessing other databases containing information related to such logbook information.

Moreover, it provides such a system further comprising: implementing inputting such logbook information using at least one stand-alone device; implementing storing such inputted logbook information on such at least one stand-alone device; implementing transmitting such stored logbook information from such at least one stand-alone device to at least one local area network; implementing transmitting such stored logbook information from such at least one stand-alone device to at least one wide area network; and implementing storing such transmitted logbook information in such unified database system. And it also provides such a system further comprising: implementing transmitting such logbook information of such at least one user to such at least one stand-alone device from such at least one local area network; implementing transmitting such logbook information of such at least one user to such at least one stand-alone device from such at least one wide area network; implementing storing such logbook information on such at least one stand-alone device; and implementing displaying such logbook information stored on such at least one stand-alone device to such at least one user. And it further provides such a system further comprising: implementing inputting such logbook information on at least one wireless device; implementing storing such inputted logbook information on such at least one wireless device; implementing transmitting such stored logbook information from such at least one wireless device to at least one local area network; implementing transmitting such stored logbook information from such at least one wireless device to at least one wide area network; and implementing storing such transmitted logbook information in such unified database system. And it provides such a system further comprising: implementing transmitting such logbook information of such at least one user to such at least one wireless device from such at least one local area network; implementing transmitting such logbook information of such at least one user to such at least one wireless device from such at least one wide area network; implementing storing such logbook information on such at least one wireless device; and implementing displaying such logbook information stored on such at least one wireless device to such at least one user.

Furthermore this invention provides such a system further comprising: implementing inputting completion information related to at least one task of at least one checklist by such at least one user; implementing storing in such inputted completion information related to such at least one task of such at least one checklist; implementing selecting at least one set of such stored completion information related to such at least one task of such at least one checklist by such at least one user; and implementing displaying such at least one set of such completion information related to such at least one task of such at least one checklist. And it also provides such a system wherein such at least one checklist, further comprises: at least one equipment checklist; at least one equipment pre-use checklist; at least one equipment in-use checklist; and at least one equipment post-use checklist. And it further provides such a system further comprising permitting modification of at least one user interface screen by such at least one user to meet personal requirements of such at least one user.

According to a preferred embodiment thereof, this invention provides an Internet website client-server computer system comprising: at least one computer interface system structured and arranged to assist input of individual logbook information on behalf of at least one first user of a population of first users; at least one unified database system structured and arranged to store such individual logbook information; at least one computer processor system structured and arranged to assist accessing of such individual logbook information by at least one second user; and at least one computer processor system structured and arranged to assist accessing of such individual logbook information by such at least one first user of such population of first users. And it provides such a system further comprising at least one computer processor structured and arranged to retrieve at least one outside record relating to such individual logbook information.

And it provides such a system further comprising: at least one computer interface system structured and arranged to selectively control access to such individual logbook information by such at least one second user; at least one computer interface system structured and arranged to selectively grant access privileges to such at least one second user; and at least computer processor system structured and arranged to selectively restrict such access privileges of such at least one second user to at least one particular portion of such individual logbook information. It also provides such a system further comprising: at least one computer interface system structured and arranged to set at least one requirement for compliance for at least one such first user by at least one such second user; at least computer processor system structured and arranged to identify impending non-compliance with at least one such requirement for compliance by at least one such first user as set by at least one such second user; and at least one computer processor system structured and arranged to notify at least one such first user of their impending non-compliance with at least one such requirement for compliance. It also provides such a system further comprising at least one computer processor system structured and arranged to notify at least one such second user of impending non-compliance with at least one such particular requirement for compliance for at least one such first user. And it provides such a system further comprising: at least one computer processor system structured and arranged to identify non-compliance with at least one such requirement for compliance as set by at least one such first user; and at least one computer processor system structured and arranged to notify at least one such first user of their non-compliance with at least one such requirement for compliance.

In addition, this invention provides such a system further comprising: at least one computer processor system structured and arranged to notify at least one such second user of non-compliance with at least one such particular requirement for compliance for at least one such first user. It also provides such a system further comprising: at least one computer processor system structured and arranged to request at least one electronic authorization signature from at least one such second user relating to such individual logbook information of at least one such first user; and at least one computer interface system structured and arranged to input at least one such authorization signature relating to such individual logbook information of at least one such first user by at least one such second user; and wherein such at least one unified database system is structured and arranged to store electronic authorization signatures relating to such logbook information. Also it provides such a system further comprising: at least one computer processor system structured and arranged to request at least one electronic endorsement signature relating to such individual logbook information of at least one such first user by at least one such second user; and at least one computer interface system structured and arranged to input at least one such electronic endorsement signature by at least one such second user relating to such individual logbook information of at least one such first user; wherein such at least one unified database system is structured and arranged to store at least one such electronic endorsement signature relating to such individual logbook information of at least one such first user.

Additionally it provides such a system further comprising: at least one computer interface system structured and arranged to set the selection criteria by at least one such second user from such individual logbook information; at least one computer processor system structured and arranged to select a set of such individual logbook information; and at least one computer interface system structured and arranged to present at least one such set of such individual logbook information for viewing by at least one such second user. And it provides such a system wherein such computer interface system for assisting input of individual logbook information on behalf of at least one first user of a population of first users further comprises: at least one computer interface system structured and arranged to input such individual logbook information using at least one stand-alone device; at least one computer processor system structured and arranged to store such inputted such individual logbook information on such at least one stand-alone device; and at least one computer transmitter system structured and arranged to transmit such individual logbook information from at least one such stand-alone device to such unified database system. It also provides such a system further comprising: at least one computer transmitter system structured and arranged to transmit such individual logbook information from at least one such unified database system to at least one such stand-alone device; at least one computer processor system for storing such transmitted such logbook information on such at least one stand-alone device; and at least one computer interface system structured and arranged to present at least one such set of such individual logbook information using at least one stand-alone device for viewing by at least one such second user.

Further, this invention provides such a system wherein such computer interface system structured and arranged for assisting input of individual logbook information on behalf of at least one first user of a population of first users further comprises: at least one computer interface system structured and arranged to input such individual logbook information using at least one wireless device; at least one computer processor system structured and arranged to store such inputted such individual logbook information on such wireless device; and at least one computer transmitter system structured and arranged to transmit such stored individual logbook information from at least one such wireless device to such unified database system. And it provides such a system further comprising: at least one computer transmitter system structured and arranged to transmit such individual logbook information from at least one such unified database system to at least one such wireless device; at least one computer processor system for storing such transmitted logbook information on such at least one wireless device; and at least one computer interface system structured and arranged to present at least one such set of such stored individual logbook information using at least one wireless device for viewing by at least one such second user. And it provides such a system further comprising: at least one computer interface system structured and arranged to input completion information related to at least one task of at least one by at least one such second user; at least one computer processor system structured and arranged to store in such unified database system such inputted completion information related to at least one such task of at least one such checklist; at least one computer processor system structured and arranged to select at least one set of such stored completion information related to at least one such task of at least one such checklist by at least one such second user; and at least one computer interface system structured and arranged to present at least one such set of such stored completion information related to at least one such task of at least one such checklist.

Still further it provides such a system wherein such at least one checklist, further comprises: at least one equipment checklist; at least one equipment pre-use checklist; at least one equipment in-use checklist; and at least one equipment post-use checklist. And it provides such a system further comprising: at least one computer processor system structured and arranged to combine such individual logbook information directly with other electronic documents to form a combined document; at least one computer processor system structured and arranged to analyze at least one such combined document details; and at least one computer interface system structured and arranged to present results of such analysis to at least one such second user. It also provides such a system further comprising at least one computer interface system structured and arranged to permit modification of at least one user interface screen by such at least one user meet personal requirements of such at least one user.

In accordance with a preferred embodiment thereof, this invention provides an Internet website client-server computer system comprising: computer-assisting input of individual logbook information on behalf of at least one first user of a population of first users; computer-assisting storing in such at least one unified database system such individual logbook information; computer-assisting accessing of such individual logbook information by at least one second user; and computer-assisting accessing of such individual logbook information by such at least one first user of such population of first users. And it provides such a system further comprising: computer-assisting retrieval of at least one outside record relating to such individual logbook information. It also provides such a system further comprising: computer-assisting selectively controlling access to such individual logbook information by such at least one second user; computer-assisting selectively granting access privileges to such at least one second user; and computer-assisting selectively restricting such access privileges of such at least one second user to at least one particular portion of such individual logbook information. And it provides such a system further comprising: computer-assisting setting at least one requirement for compliance for at least one such first user by at least one such second user; computer-assisting identifying impending non-compliance with at least one such requirement for compliance by at least one such first user as set by at least one such second user; and computer-assisting notifying at least one such first user of their impending non-compliance with at least one such requirement for compliance.

In addition, it provides such a system further comprising: computer-assisting notifying at least one such second user of impending non-compliance with at least one such particular requirement for compliance for at least one such first user. And it provides such a system further comprising: computer-assisting identifying non-compliance with at least one such requirement for compliance as set by at least one such first user; and computer-assisting notifying at least one such first user of their non-compliance with at least one such requirement for compliance. It also provides such a system further comprising computer-assisting notifying at least one such second user of non-compliance with at least one such particular requirement for compliance for at least one such first user. And it provides such a system further comprising: computer-assisting requesting at least one electronic authorization signature from at least one such second user relating to such individual logbook information of at least one such first user; computer-assisting inputting at least one such authorization signature relating to such individual logbook information of at least one such first user by at least one such second user; and computer-assisting for storing in such unified database system electronic authorization signatures relating to such logbook information. It also provides such a system further comprising: computer-assisting requesting at least one electronic endorsement signature relating to such individual logbook information of at least one such first user by at least one such second user; computer-assisting inputting at least one such electronic endorsement signature by at least one such second user relating to such individual logbook information of at least one such first user; and computer-assisting storing in such unified database system at least one such electronic endorsement signature relating to such individual logbook information of at least one such first user.

Yet further, this invention provides such a system further comprising: computer-assisting setting the selection criteria by at least one such second user from such individual logbook information; computer-assisting selecting a set of such individual logbook information; and computer-assisting presenting a at least one such set of such individual logbook information for viewing by at least one such second user. And it provides such a wherein such computer interface system is structured and arranged to assist input of individual logbook information on behalf of at least one first user of a population of first users further comprises: computer-assisting inputting such individual logbook information using at least one stand-alone device; computer-assisting storing such inputted individual logbook information on such at least one stand-alone device; and computer-assisting transmitting such stored individual logbook information from at least one such stand-alone device to such unified database system. It also provides such a further comprising: computer-assisting transmitting such individual logbook information from at least one such unified database system to at least one such stand-alone device; computer-assisting storing such transmitted such logbook information on such at least one stand-alone device; and computer-assisting presenting at least one such set of stored individual logbook information using at least one such stand-alone device for viewing by at least one such second user.

And it provides such a system wherein such computer-assisting input of individual logbook information on behalf of at least one first user of a population of first users further comprises: computer-assisting inputting such individual logbook information using at least one wireless device; computer-assisting storing such inputted individual logbook information on such wireless device; and computer-assisting transmitting such stored individual logbook information from at least one such wireless device to such unified database system. It also provides such a system further comprising: computer-assisting transmitting such individual logbook information from at least one such unified database system to at least one such wireless device; computer-assisting storing such transmitted such logbook information on such at least one wireless device; and computer-assisting presenting at least one such set of such individual logbook information using at least one wireless device for viewing by at least one such second user. And it provides such a system further comprising: computer-assisting inputting completion information related to at least one task of at least one checklist by at least one such second user; computer-assisting storing in such unified database system such inputted completion information related to at least one task of at least one checklist; computer-assisting selecting at least one set of such stored completion information related to at least one task of at least one checklist by at least one such second user; and computer-assisting presenting at least one such set of such stored completion information related to at least one task of at least one checklist. And it provides such a system wherein such at least one checklist, further comprises: at least one equipment checklist; at least one pre-use equipment checklist; at least one in-use equipment checklist; and at least one post-use equipment checklist. It also provides such a system further comprising: computer-assisting combining such individual logbook information directly with other electronic documents to form a combined document; computer-assisting analyzing at least one such combined document details; and computer-assisting presenting results of such analyzing to at least one such second user. And it provides such a system further comprising: computer-assisting modification of at least one user interface screen by such at least one user meet personal requirements of such at least one user.

Further, according to a preferred embodiment hereof, this invention provides an Internet website client-server computer system in which: the logbook information is associated with aviation; the information managed is associated with pilots of any type of aircraft; and the logbook information is associated with logbooks of pilots of any type of aircraft. And, according to a preferred embodiment hereof, this invention provides an Internet website client-server computer system in which: the logbook information is associated with water-borne shipping; the logbook information is associated with ships; and the logbook information is associated with logbooks of ships. And, according to a preferred embodiment hereof, this invention provides an Internet website client-server computer system in which: the logbook information is associated with interstate trucking; the logbook information is associated with truck drivers; and the logbook information is associated with logbooks of truck drivers. And, according to a preferred embodiment hereof, this invention provides an Internet website client-server computer system in which: the logbook information is associated with SCUBA divers; and the logbook information is associate with logbooks of SCUBA divers.

### Definitions, Acronyms and Cross-references

Activity diagrams—This term is sometimes used herein to refer to modeling the dynamic aspects of systems. An activity diagram is essentially a flowchart, showing flow of control from activity to activity. Activity diagrams are used to model the dynamic aspects of a system. For the most part, this involves sequential (and possibly concurrent) steps in a computational process. Reference—The Unified Modeling Language User Guide: Grady Booch, James Rumbaugh, Ivar Jacobson. Addison-Wesley, Copyright 1999 ISBN 0-201-57168-4.

Alert—This term is sometimes used herein to refer to a notice sent to a pilot (or similar licensed person in another regulated field) or authoritative entity regarding a need to complete specified actions prior to a selected date to retain a certification or licensure.

Authoritative entity—This term is sometimes used herein to refer generally to any licensing-related governmental agency, school, instructor or other agency, person or regulatory body with authorization to set and maintain system policies, approve logbook entries or access the system for the purpose of enforcing regulatory requirements. (Usually used herein in connection with the licensing of pilots.)

CFI—This term is sometimes used herein to refer to certified flight instructor—a person responsible for certifying a pilot's logbook entries for training.

CIA—This term is sometimes used herein to refer to the Central Intelligence Agency.

Compliance—This term is sometimes used herein to refer to circumstances in which a pilot has met a specific regulatory requirement.

Currency—This term is sometimes used herein to refer to circumstances in which a pilot (or other similar person licensed in a regulated field) must demonstrate through entries in his/her logbook that a particular skill has been completed a required number of times within a specified period of time.

Embedded—This term is sometimes used herein to refer to the ability to allow a document to contain data from various sources. This may or may not be the document creator. For example, in the case of the logbook distribution to a Job Center, the implementation could accomplished in a variety of ways, via SOAP, HTML, XML, etc. and could reside either with the creator of the document or outside the presence of the document creator with the creator of the data or other entity.

Endorsement—This term is sometimes used herein to refer to certification by an authoritative entity that a pilot (or other similar person licensed in a regulated field) has demonstrated a required level of skill as a prerequisite for advancement.

FAA—This term is sometimes used herein to refer to the Federal Aviation Administration.

FARs—This term is sometimes used herein to refer to Federal Aviation Regulations.

FBI—This term is sometimes used herein to refer to the Federal Bureau of Investigation.

Geo-political—This term is sometimes used herein to refer to the combination of geographic and political boundaries delineating a country or region or area.

Internet—This term is meant herein to refer to the “Internet”, an electronic communications network that connects computer networks and organizational computer facilities around the world, and this term as used herein includes any future successor to the Internet or any large WAN having similar capabilities.

INS—This term is sometimes used herein to refer to the Immigration and Naturalization Service.

LAN (Local Area Network)—This term is sometimes used herein to refer to a system that links together electronic office equipment, such as computers and word processors, and forms a network within an office or building.

Notification—This term is sometimes used herein to refer to notice sent to a pilot (or other similar person licensed in a regulated field) or authoritative entity regarding failure of a pilot (or other similar person licensed in a regulated field) to comply with a specific requirement prior to a specified date.

NSA—This term is sometimes used herein to refer to National Security Agency.

PDA (Personal Digital Assistant)—This term is sometimes used herein to refer to a small hand held computer with or without wireless access to the Internet. A lightweight, hand-held, usually pen-based computer often, but not always, used as a personal organizer.

SOAP (Simple Object Access Protocol)—This term is sometimes used herein to refer to a lightweight protocol for exchange of information in a decentralized, distributed environment. It is an XML-based protocol that consists of three parts: an envelope that defines a framework for describing what is in a message and how to process it, a set of encoding rules for expressing instances of application-defined data types, and a convention for representing remote procedure calls and responses. SOAP can potentially be used in combination with a variety of other protocols. Reference—World Wide Web Consortium definition (See http://www.w3.org/tr/soap).

UML (Unified Modeling Language)—This term is sometimes used herein to refer to a graphical language for visualization, specifying, constructing, and documenting the artifacts of a software-intensive system. The UML gives you a standard way to write a system's blueprints, covering conceptual things, such as business processes and system functions, as well as concrete things, such as classes written in a specific programming language, database schemas, and reusable software components. References—The Unified Modeling Language User Guide: Grady Booch, James Rumbaugh, Ivar Jacobson. Addison-Wesley, Copyright 1999 ISBN 0-201-57168-4; The Unified Modeling Language Reference Manual: Grady Booch, James Rumbaugh, Ivar Jacobson. Addison-Wesley, Copyright 1999 ISBN 0-201-30998-X; UML In A Nutshell A desktop quick reference: Sinan Si Alhir. O'Reilly & Associates, Inc., Copyright 1998 ISBN 1-56592-448-7; UML Distilled, second edition: Martin Fowler with Kendall Scott. Addison-Wesly, Copyright 2000 ISBN 0-201-65783-X.

Use Case—This term is sometimes used herein to refer to a specification of the behavior of a system or a part of a system and is a description of a set of sequences of actions, including variants that a system performs to yield an observable result of value to an actor. Use cases are applied to capture the intended behavior of the system you are developing, without having to specify how that behavior is implemented. References—The Unified Modeling Language User Guide: Grady Booch, James Rumbaugh, Ivar Jacobson. Addison-Wesley, Copyright 1999 ISBN 0-201-57168-4.

Use Case Diagram—This term is sometimes used herein to refer a description of the functionality of a system and users of the system. References—UML In A Nutshell A desktop quick reference: Sinan Si Alhir. O'Reilly & Associates, Inc., Copyright 1998 ISBN 1-56592-448-7;

WAN (Wide Area Network)—This term is sometimes used herein to refer to a communications network that uses such devices as telephone lines, satellite dishes, or radio waves to span a larger geographic area than can be covered by a LAN.

WSQ—This term is sometimes used herein to refer to the FBI's Wavelet/Scalar Quantization Specification for compression of digitized gray-scale fingerprint images.

XML (Extensible Markup Language)—This term is sometimes used herein to refer to the universal format for structured documents and data on the Web. Reference—World Wide Web Consortium definition (See http://www.w3.org/XML/).

### BRIEF DESCRIPTION OF THE DRAWINGS

FIG. 1 illustrates applicant's preferred methods and practices for managing the tasks necessary for recording and displaying information necessary for an Internet-based logbook system that meets the identified requirements.

FIG. 2 illustrates an overview use case diagram of the preferred logbook system.

FIG. 3 illustrates a use case diagram of how logbook details are preferably embedded in electronic documents.

FIG. 4 illustrates a use case diagram of the preferred processes for review of logbook records by authoritative entities.

FIG. 5 presents a use case diagram that describes the preferred logbook management processes.

FIG. 6 presents a use case diagram that describes the preferred logbook system administration processes.

FIG. 7 presents a use case diagram of the preferred processes for reporting from the logbook system.

FIG. 8 presents a use case diagram of the preferred processes for managing logbook extensions in the field of aviation.

FIG. 9 illustrates a use case diagram of the preferred electronic signature processes.

FIG. 10 presents a use case diagram of the preferred electronic endorsement processes.

FIG. 11 presents a use case diagram of the preferred Alert process.

FIG. 12A presents a logbook example of a preferred electronic display screen image of an electronic signature request.

FIG. 12B presents a logbook example of a preferred electronic display screen image illustrating electronic signature notification to an authoritative entity.

FIG. 12C presents a logbook example of a preferred electronic display screen image illustrating locked records after electronic signature approval by an authoritative entity.

FIG. 12D presents logbook example of a preferred electronic display screen image illustrating electronic signature approval and note of a logbook entry.

FIG. 13A shows a preferred resume screen with embedded log information.

FIG. 13B shows a preferred search facility screen for finding resume records in a logbook.

FIG. 13C illustrates a preferred search results list of resumes from a logbook database.

FIG. 14A presents an example of the preferred entry and edit screen for creating and updating a resume.

FIG. 14B illustrates an example of a preferred screen for removing a resume from a logbook database.

FIG. 15 illustrates a preferred electronic display screen image of an embedded logbook in a web page.

FIGS. 16A-16C show three preferred forms and reports that can preferably be accessed through the logbook.

FIGS. 17A-17B present preferred web pages with different implementations of the display format for time.

FIG. 18 illustrates a preferred web page implementation of a screen enabling a user to select fields, etc., for display.

FIG. 19A presents an example of a preferred web page for adding a new logbook entry, with defaults filled in.

FIG. 19B shows examples of a preferred set of screens for adding a new logbook entry using a PDA.

FIG. 20 illustrates an example of a preferred web page showing how a user may specify default values for the logbook (as shown in FIG. 19A).

FIG. 21A illustrates an example of a preferred web page implementation of a filter to be applied to a search.

FIG. 21B presents an illustration of a preferred screen showing the filtered logbook results of applying the filter shown in FIG. 21 A.

FIG. 22 illustrates an additional example of a preferred web page displaying summarized and filtered logbook data.

FIGS. 23A-23B illustrate additional examples of preferred web pages displaying logbook information.

FIG. 23C illustrates additional examples of preferred screens displaying logbook information on a PDA.

FIG. 24 presents an example of a preferred automated information retrieval facility within a logbook.

FIGS. 25A-25C provide examples of the preferred wording of endorsements for logbook endorsement entries.

FIG. 26A illustrates an example of a preferred web page for logbook searching using specific criteria.

FIG. 26B illustrates an example of a preferred web page summary display of results from the search criteria used in FIG. 26A.

FIG. 26C presents an example of a preferred detail display of results from the search criteria used in FIG. 26A.

FIG. 27 illustrates the FBI WSQ algorithm used for identifying and storing fingerprint data.

FIG. 28 illustrates a web page example of the preferred use of electronic signature endorsements for a logbook.

FIG. 29 presents an example of a preferred implementation of Alert (Currency) notification for a logbook.

FIG. 30 illustrates the Alert in FIG. 29 transmitted to a logbook user when the criteria for the alert were met.

FIG. 31 illustrates a web service using a SOAP interface to deliver the preferred functionality of a logbook, via the Internet, in an XML database interface.

FIG. 32 presents the GetMySigners service from FIG. 31 and sample called SOAP software code to return the requested information to a user.

FIG. 33 illustrates sample XML code that results from the call in FIG. 31 calling function GetMySigners( ) for a user. This further illustrates how multiple web page interfaces may preferably be provided to different user.

FIG. 34 presents a web page illustration of the user information preferably maintained in the preferred logbook database.

### DETAILED DESCRIPTION OF A PREFERRED EMBODIMENT OF THE INVENTION

According to a preferred embodiment of the present invention, a business method and software system is described with features for recording and displaying actions and activities in an electronic logbook and, more specifically, to a system in which actions and activities are recorded, assigned to an individual, and reviewed or approved by authoritative entities through the use of electronic signatures. Further, other areas addressed by a preferred embodiment of the present invention include storage of information specific to the needs of all individuals and authoritative entities, separable responsibility for segments of the database, reporting and searching, automated notifications and alerts, collection and reporting of endorsements, database integration, completion of required forms, and, for example, compliance with FAA 61.51 requirements and the use of XML and SOAP protocols to deliver the required functionality to all users.

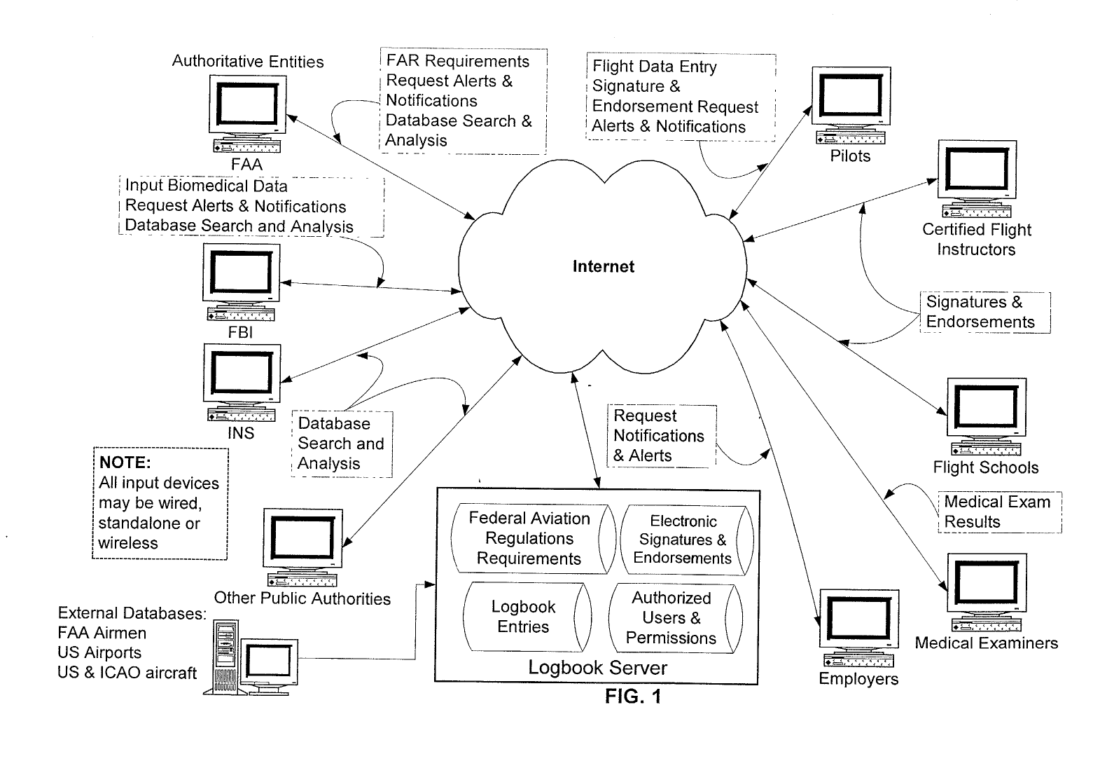

According to a preferred embodiment of the present invention, information regarding pilots' logbook entries, the federal regulations (FARs) governing pilots' usage, certification of entries, compliance with proficiency requirements, medical fitness, and unique biomedical identifications will preferably be stored in a centralized database. The information stored will then preferably be accessible to authorized users for input, update and analysis. As shown in FIG. 1, a wide variety of authoritative entities, individuals, certified flight instructors, flight schools, medical examiners and employers will benefit from a centralized database system accessible through the Internet. Preferably, the FAA will be the governing authority responsible for authorizing access to the various functions and information in the system. Preferably, the FAA will also assign responsibility for input and maintenance of various segments of the information.

According to a preferred embodiment of the present invention, a method and system (software) is provided for recording actions and activity of both animate and inanimate objects. The system preferably records (logs) single, multiple, or a series of single or multiple activities or actions that have been entered into the system by a user and are assigned to the user by a unique identifier.

As shown in FIG. 1, the preferred system is comprised of an input/display device and a server system on which a record of actions and activities is stored. The input/display device preferably includes, but is not limited to, a device that is stationary (not normally moved from one location to another) such as a personal computer or mobile device (by design intended to be used from multiple locations) such as a personal digital assistant (PDA). The input/display device is either directly connected (wired) to a local area network or a wide area network, or is connected through a transmitter/receiver (wireless) connection to a local or a wide area network that is in turn connected to the server system via the Internet.

As the actions or activities are recorded, preferably they are displayed on the input/display device and stored within the input/display device or transmitted directly to the local or wide area network. Preferably, if recorded on the input/display device, the log can be transmitted to the server system immediately or at a later date.

The Internet server system preferably receives and stores the log of actions or activities. It preferably identifies those actions or activities that require approval or verification from an authority. In a preferred embodiment, for those actions or activities that require approval or verification, an electronic notification can be transmitted from the server system preferably via electronic mail to an authoritative entity. The authoritative entity can then preferably access the server system, and authorize the actions or activities. Preferably, the authorization is recorded as part of the actions or activities record. In another preferred embodiment, an electronic compliance/noncompliance notification can preferably be transmitted to authoritative entities and/or the user for actions or activities that must be completed and recorded to meet an established requirement set by an authoritative entity or logbook user.

The electronic signature and endorsement facility preferably enables a user to obtain a verifying signature without the need to print a “paper” copy of the record. If changes to the record are required, the electronic signature must preferably be removed by the authoritative entity that applied the signature to the record originally (assuming the authoritative entity would have permission based on the business rules defined for that entity). In a preferred embodiment, the system emails a notification of the review or authorization requirement on one or more specific records to the authorizing entity. The logbook details are preferably embedded directly into other electronic documents where all combined document details, both those from the logbook and the original document, can be searched, sorted, maintained and filtered (queried).

Preferably, each user of the logbook system is assigned a unique identifying code that is associated with the records the user adds to the logbook system. The logbook system stores a record of each activity or action entered. These records can be accessed and modified through various input devices like personal computers (PC), kiosks, computer servers, or personal data assistants (PDA). The records can be displayed electronically, printed in hardcopy format, sorted, filtered (queried), searched and/or summarized. The logbook system resides or can reside on various computer systems, PC systems, server systems, kiosks and PDAs. When a record is added directly to the system, it is stored within the system. When a record is added using a PDA, it is stored within the PDA and uploaded into the system at a later time and/or communicated directly via the Internet or WAN/LAN to the server system. The logbook can be connected to various external databases where information from those databases can be combined with logbook records contained in the system.

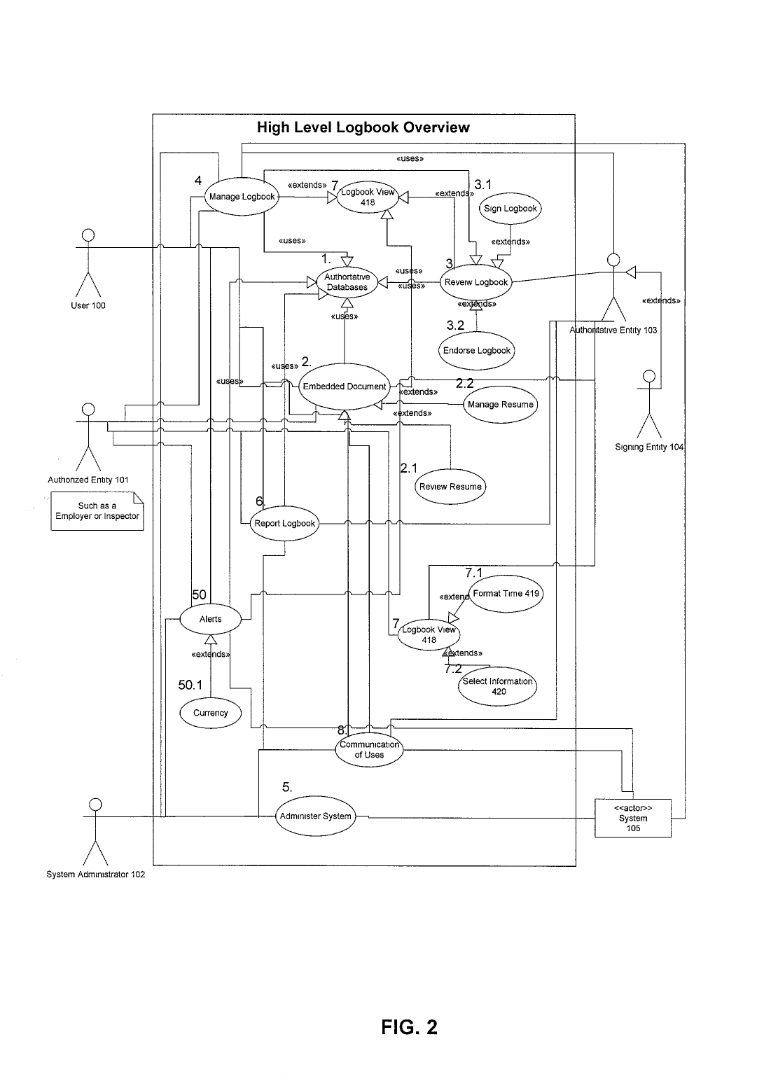

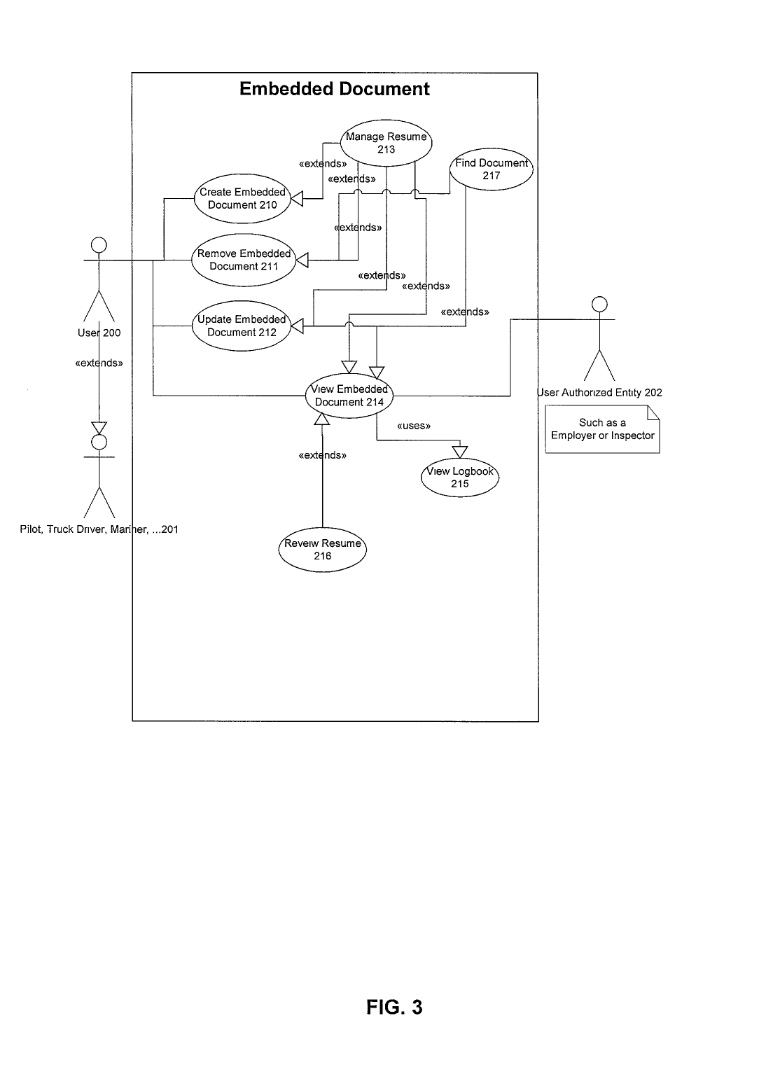

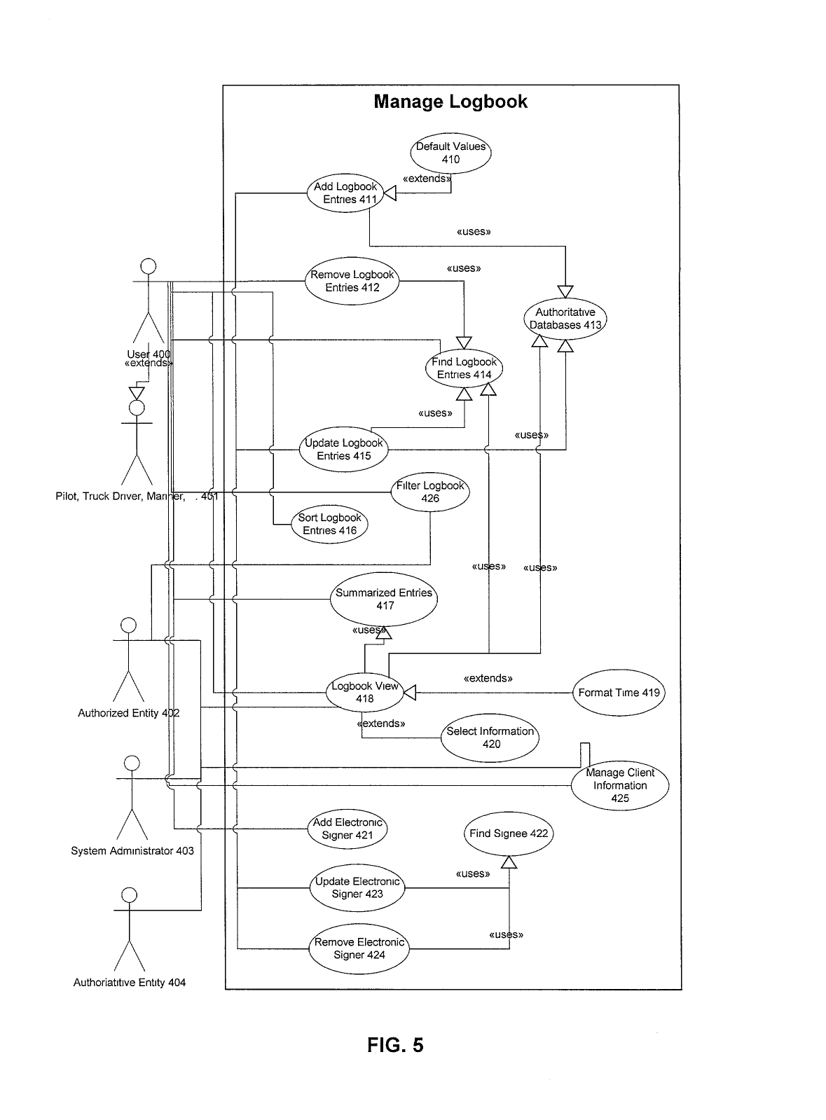

FIG. 2 is a diagram showing a high level overview of the logbook processes according to a preferred embodiment of the present invention that illustrates the preferred relationships of the “use cases” of the preferred embodiment, with procedures and flows for logbook uses and communications. User 100, Authorized Entity 101, Authoritative Entity 103, Signing Entity 104, System 105 and System Administrator 102 preferably communicate to Manage Logbook 4, which preferably contains many items, as illustrated in FIG. 5. As shown by FIG. 2, Manage Logbook 4 preferably uses Logbook View 7, Review Logbook 3, and Authoritative Databases 1. The User 100 and Authorized Entity 101 communicate to the Embedded Document 2, which preferably contains many items, as illustrated in FIG. 3. As shown, Embedded Document 2 preferably uses Logbook View 7 and Authoritative Databases 1 and is preferably extended by Manage Resume 2.2 and Review Resume 2.1. This arrangement embodies herein permitting substantially all users of at least one population of such users in at least one specified regulated area of at least one specified geo-political area, from respective user-input stations, to input respective data packets relating to such required logbook information to at least one Internet server; and storing of such inputted required logbook information in at least one unified database system. This arrangement embodies herein at least one computer interface system structured and arranged to assist input of individual logbook information on behalf of at least one first user of a population of first users; at least one unified database system structured and arranged to store said individual logbook information; at least one computer processor system structured and arranged to assist accessing of said individual logbook information by at least one second user; and at least one computer processor system structured and arranged to assist accessing of said individual logbook information by said at least one first user of said population of first users. First users herein include principle logbook users and second users herein include authoritative entities and other interested parties as well as principle logbook users. This arrangement embodies herein computer-assisting input of individual logbook information on behalf of at least one first user of a population of first users; computer-assisting storing in such at least one unified database system such individual logbook information; computer-assisting accessing of said individual logbook information by at least one second user; and computer-assisting accessing of said individual logbook information by said at least one first user of said population of first users.

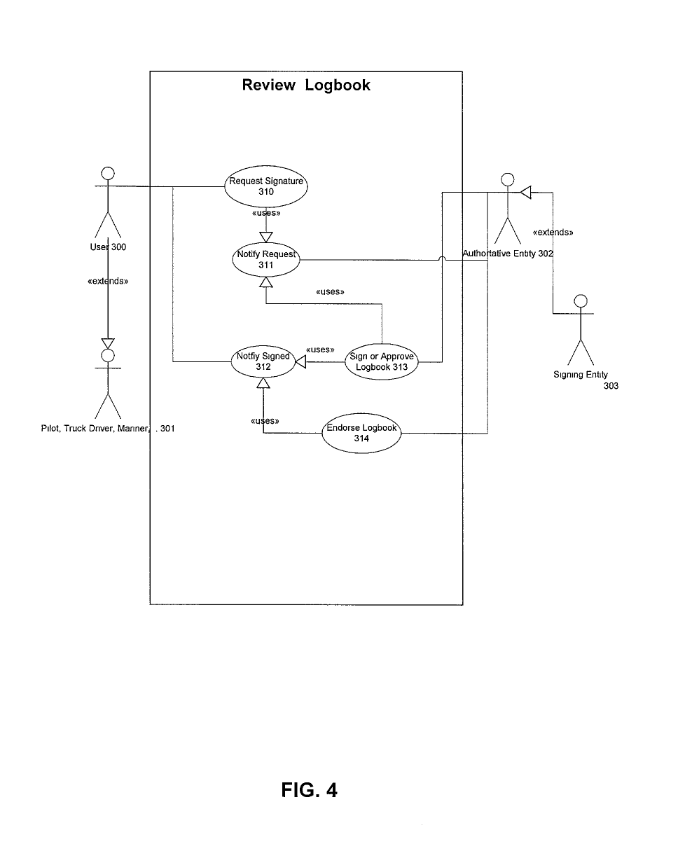

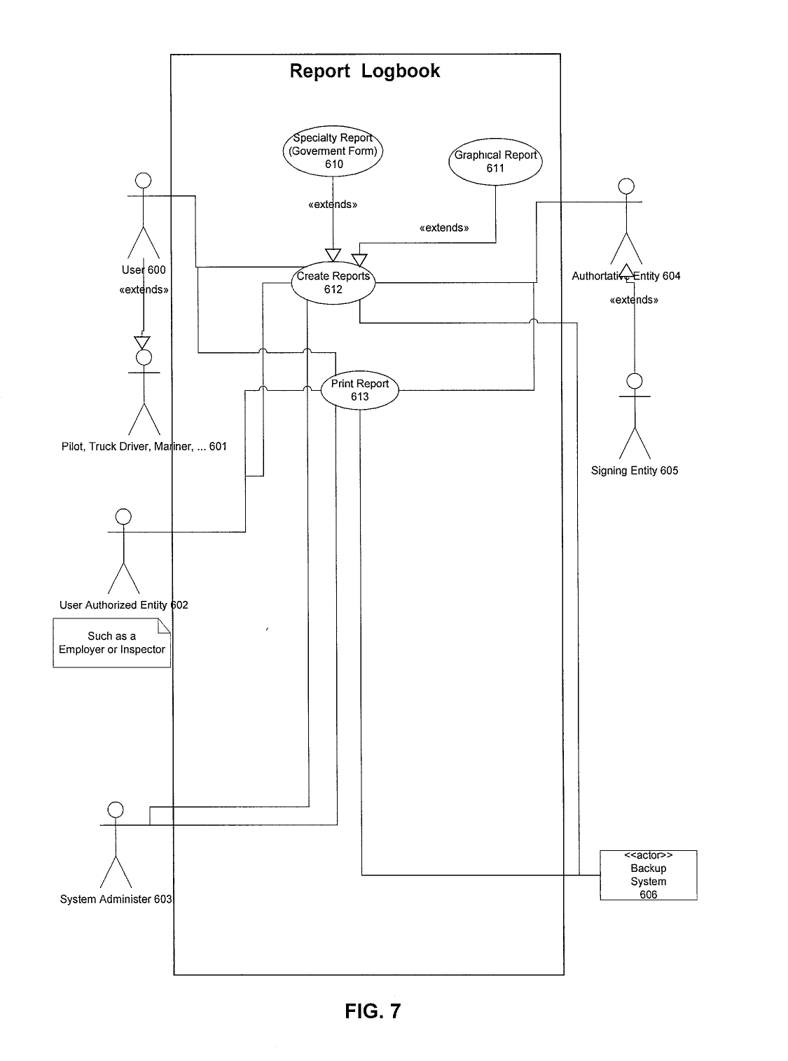

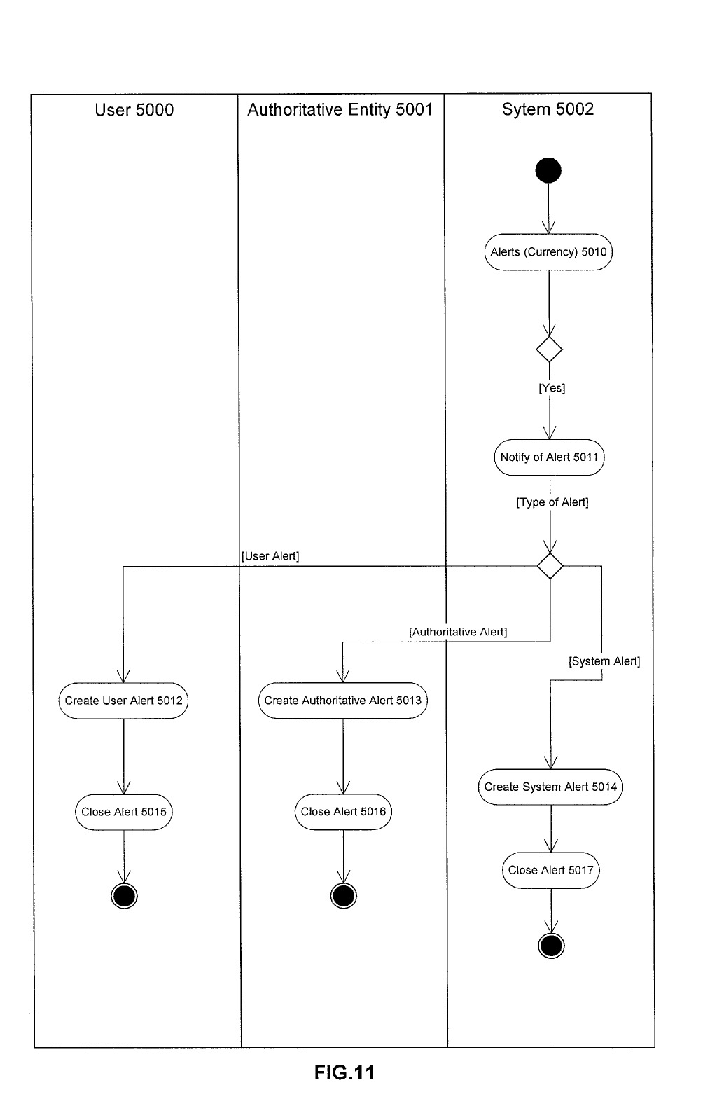

The User 100, Authorized Entity 101, Authoritative Entity 103, Signing Entity 104 and System Administrator 102 all preferably communicate to the Report Logbook 6, which preferably contains many items, as illustrated in FIG. 7. As shown, Report Logbook 6 preferably uses Authoritative Databases 1. Authorized Entity 101, Authoritative Entity 103 and Signing Entity 104 communicate to Logbook View 7,which is preferably extended by Format Time 7.1 and Select Information 7.2. User 100, Authorized Entity 101, Authoritative Entity 103, System Administrator 102, Signing Entity 104 and Backup System 105 all preferably communicate to Communications of Uses 8. Administrator 102 and Backup System 105 preferably communicate to Administer System 5. Authoritative Entity 103 and Signing Entity 104 preferably communicate to Review Logbook 3, which preferably contains many items as illustrated in FIG. 4. As shown, Review Logbook 3 preferably uses Logbook View 7, which is extended by Sign Logbook 3.1 and Endorse Logbook 3.2. The User 100, Authorized Entity 101, Authoritative Entity 103, Signing Entity 104, System 105 and System Administrator 102 preferably communicate to the Alerts 50, which preferably contains many items as illustrated in FIG. 11 and is preferably extended by Alerts 50.1 and preferably uses Authoritative Databases section 1.

Although the illustrated overview is one preferred embodiment, one skilled in the art will appreciate that, under appropriate circumstances, various sections may be omitted, rearranged or adapted in various ways for various purposes.

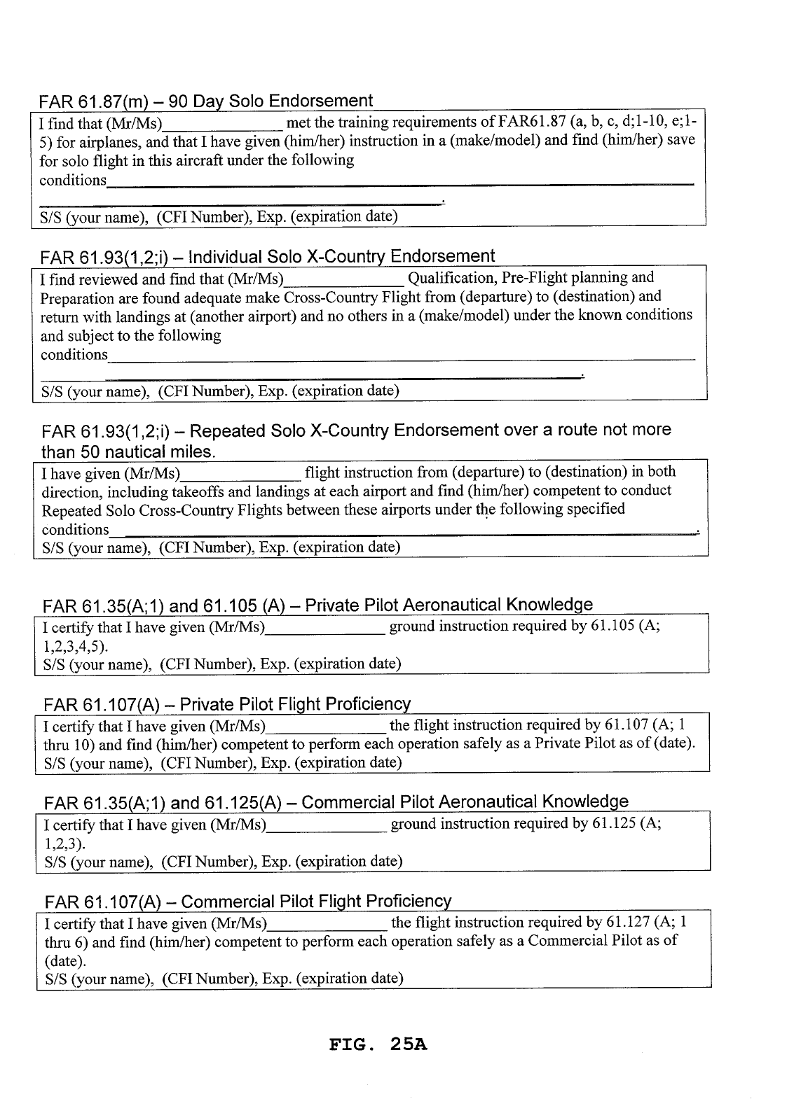

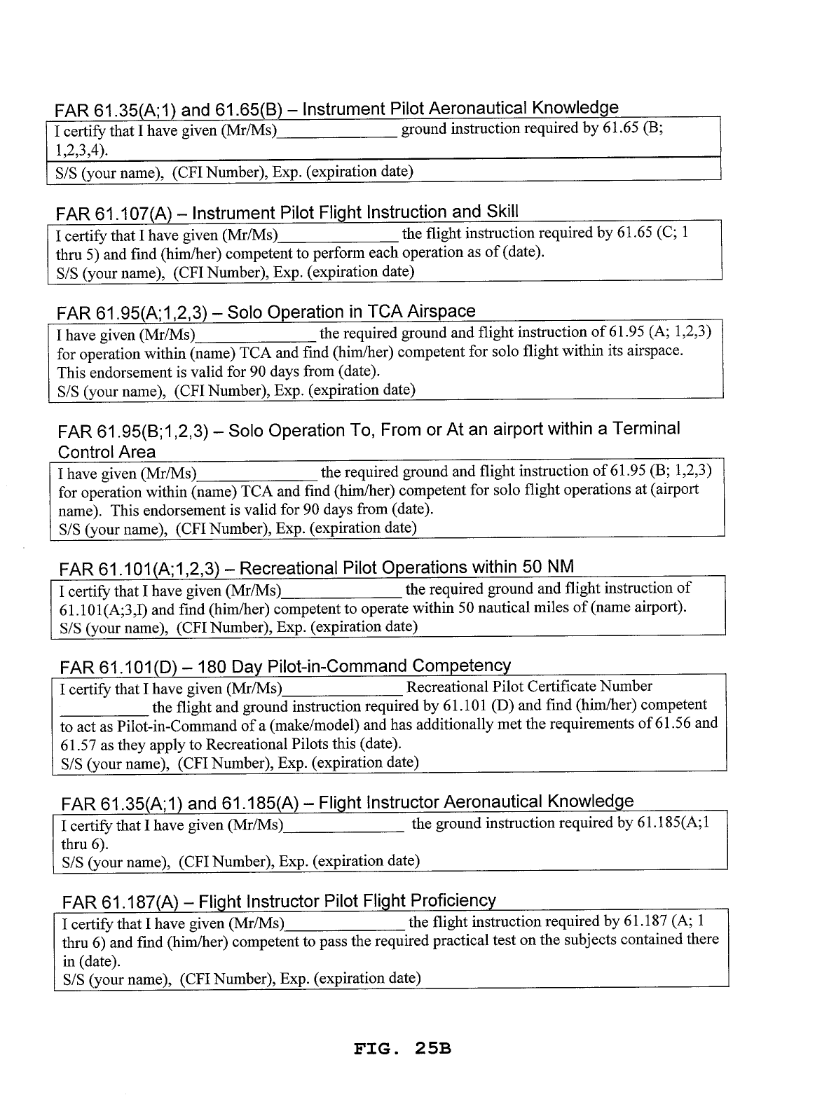

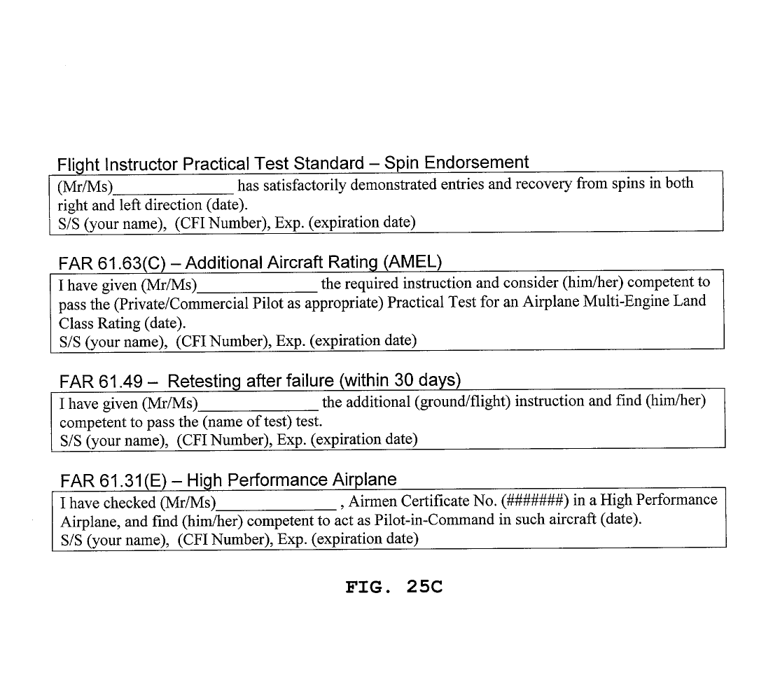

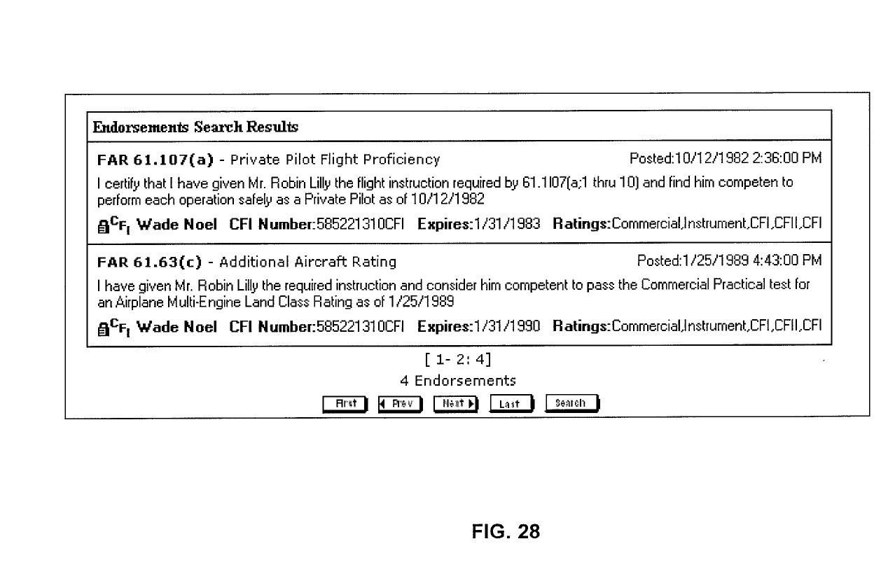

According to one preferred embodiment, Manage Logbook 4 preferably provides the capability for the user to maintain his/her logbook in an electronic format, and FIG. 5 more fully illustrates those methods, uses, communications and processes. The logbook of User 100 can be preferably tied directly to Authoritative Databases 1, such as the Federal Aviation Administration (FAA) Airmen table, the FAA Aircraft Reference table, or other related tables. This arrangement embodies herein implementing accessing other databases containing information related to such logbook information. This arrangement embodies herein at least one computer processor structured and arranged to retrieve at least one outside record relating to such individual logbook information. This arrangement embodies herein computer-assisting retrieval of at least one outside record relating to such individual logbook information. Preferably, User 100 may request that his/her logbook be Reviewed 3 and/or Electronically Signed 3.1 and/or Electronically Endorsed 3.2 by an Authoritative Entity 103 and/or a Signing Entity 104. A situation like this is when a Certified Flight Examiner (CFI) is instructing a pilot or student pilot and the CFI is required to physically sign the logbook for the flight lessons that took place. An extension to the signature could preferably go beyond the CFI to an FAA Designated Examiner, FAA, other authority, or governing entity. Further examples in aviation would preferably include allowing other authoritative entities to Review 3 or View 7 the logbook, such as a CFI or the FAA. Another example is pilot logbook endorsement. When a pilot is required to have his logbook endorsed, such as the requirement mandated in FAR 61.107(A)—Private Pilot Flight Proficiency (FIGS. 25A-25C), the CFI can preferably endorse the logbook directly, as illustrated in FIG. 28. This arrangement embodies herein an Internet website client-server computer system in which: the logbook information is associated with aviation; the information managed is associated with pilots of any type of aircraft; and the logbook information is associated with logbooks of pilots of any type of aircraft.

One skilled in the art will notice that this system for logging and communicating with authorities, etc., may, with appropriate modifications and/or under appropriate circumstances, be translated into: industries such as trucking and shipping; recreational activities, such as, golfing or SCUBA diving; education and the classroom; and the home, where activities for logging activity abound. This arrangement embodies herein an Internet website client-server computer system in which: the logbook information is associated with water-borne shipping; the logbook information is associated with ships; and the logbook information is associated with logbooks of ships. This arrangement embodies herein an Internet website client-server computer system in which: the logbook information is associated with interstate trucking; the logbook information is associated with truck drivers; and the logbook information is associated with logbooks of truck drivers. This arrangement embodies herein an Internet website client-server computer system in which: the logbook information is associated with SCUBA divers; and the logbook information is associate with logbooks of SCUBA divers.

According to a preferred embodiment of the present invention, Embedded Document 2 can be created, which gives an entity (associated or not associated with this invention) the ability to preferably create documents that contain Logbook View 4 with its uses, processes and methods. In one preferred embodiment of this invention, Embedded Document 2 may preferably be an on-line resume 2.1 that allows potential employers to search, filter and sort the resume for professional aviation personnel looking at specific details of the logbook, or details about that resume.

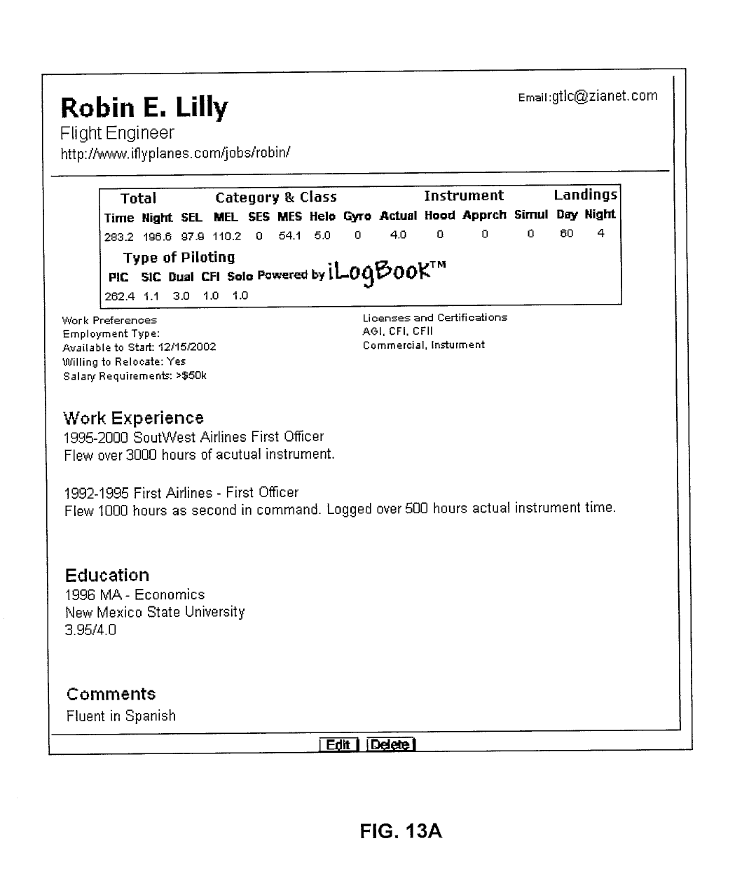

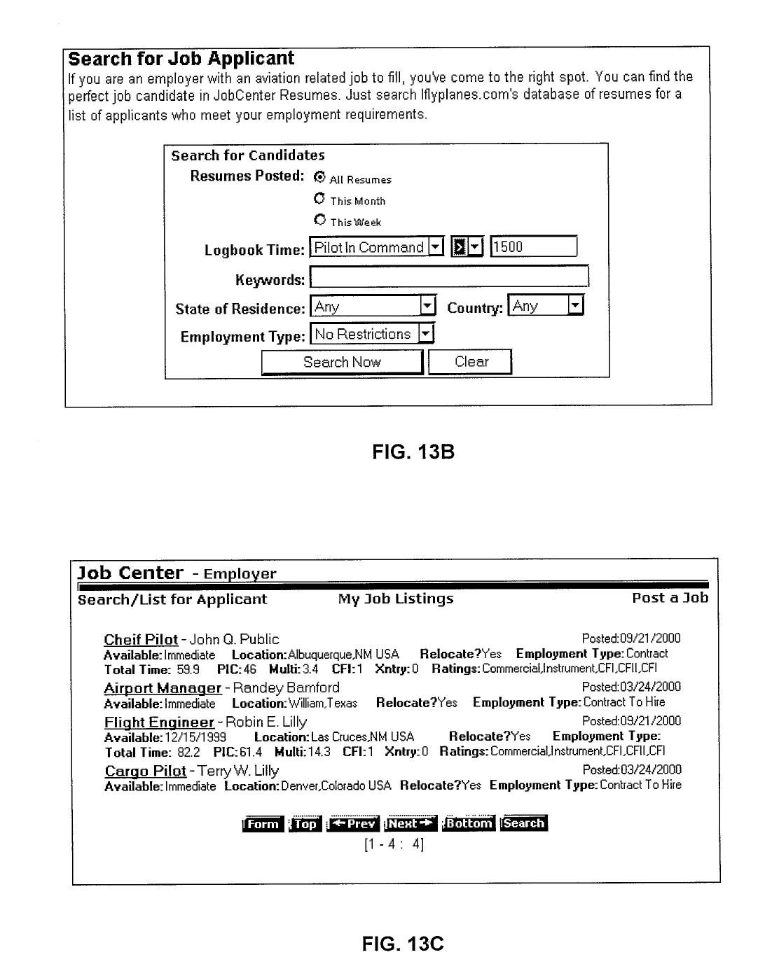

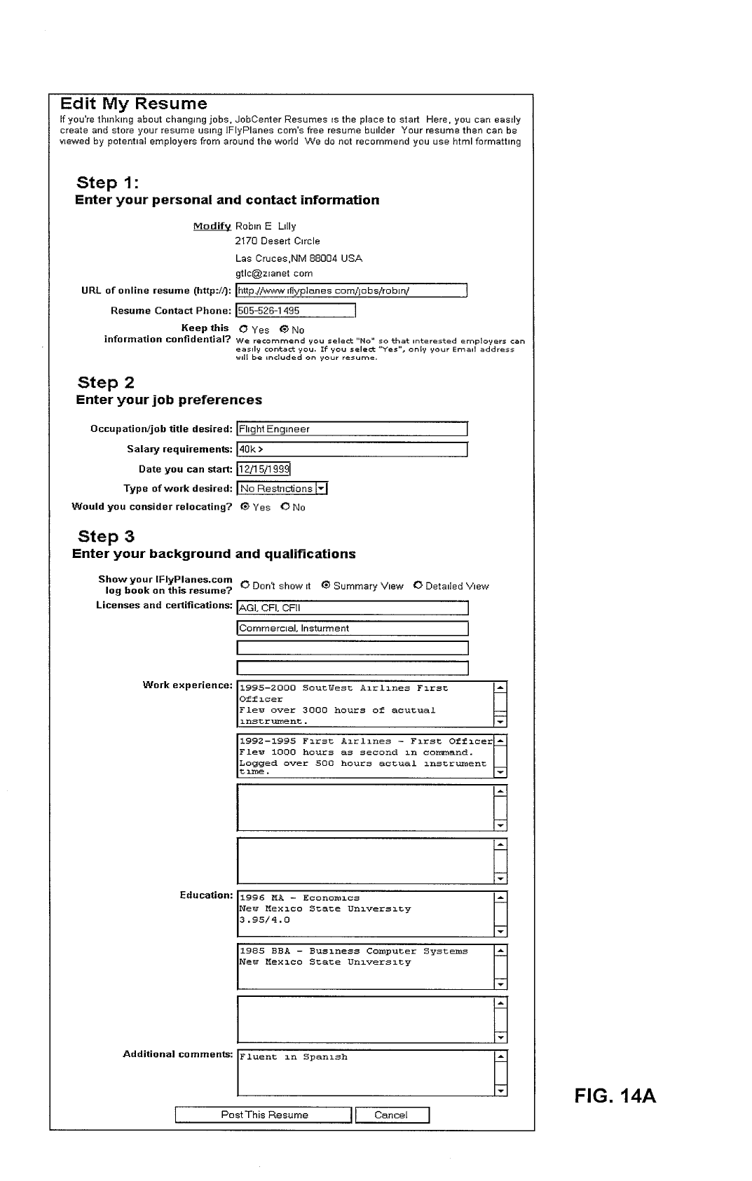

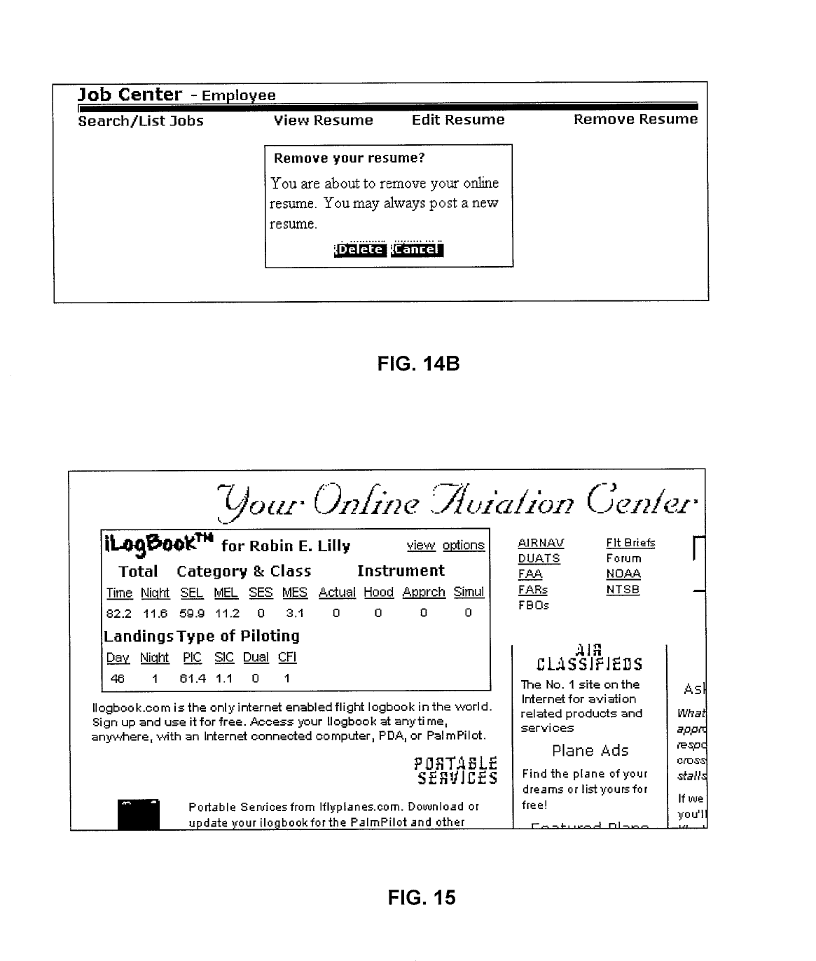

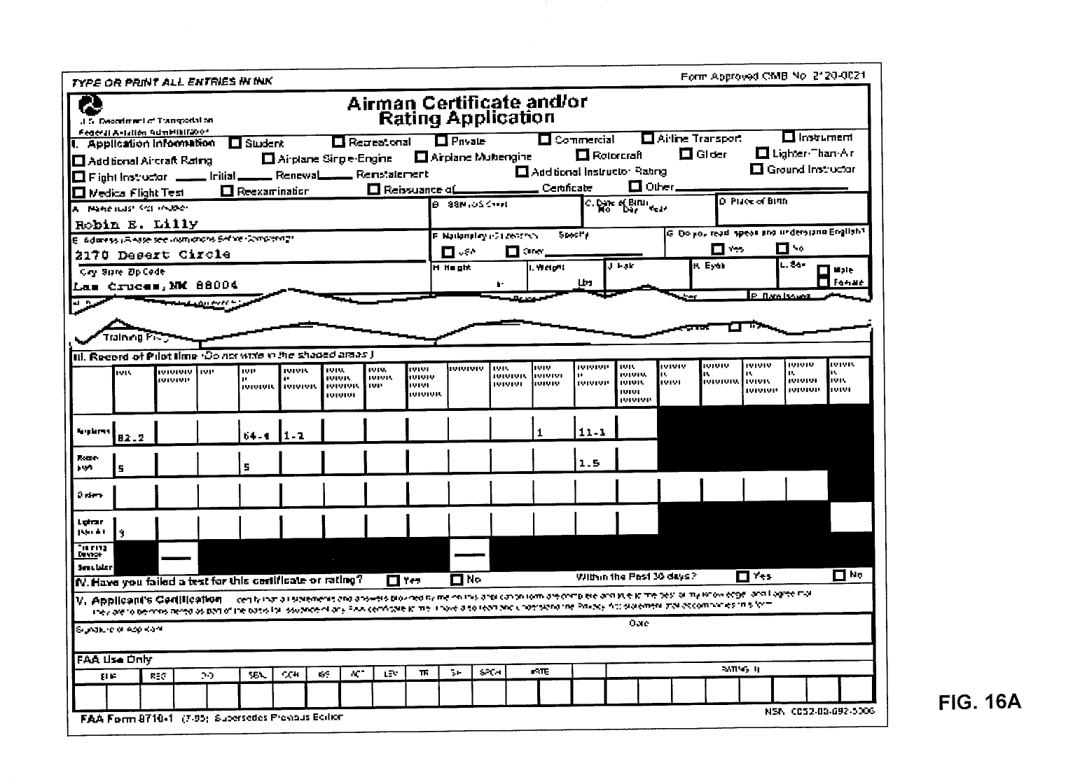

As shown in FIGS. 13A-13C an extension of the implementation Review Resume 2.1, specific to an airman in aviation, is implemented as a Hypertext Markup Language (HTML) web page. In FIGS. 13A-13C, Manage Resume 2.2 extension of the Embedded Document 2 would preferably include all those tasks needed to Manage Embedded Documents specific to Manage Resume. An HTML web page implementation of Manage Resume 2.2 specific to an airman in aviation is illustrated in FIGS. 14 A-14B. Another preferred embedded logbook is presented FIG. 15.

One skilled in the art will appreciate that the embedding of the logbook information in other documents is of importance and has many possibilities and uses beyond the examples presented.

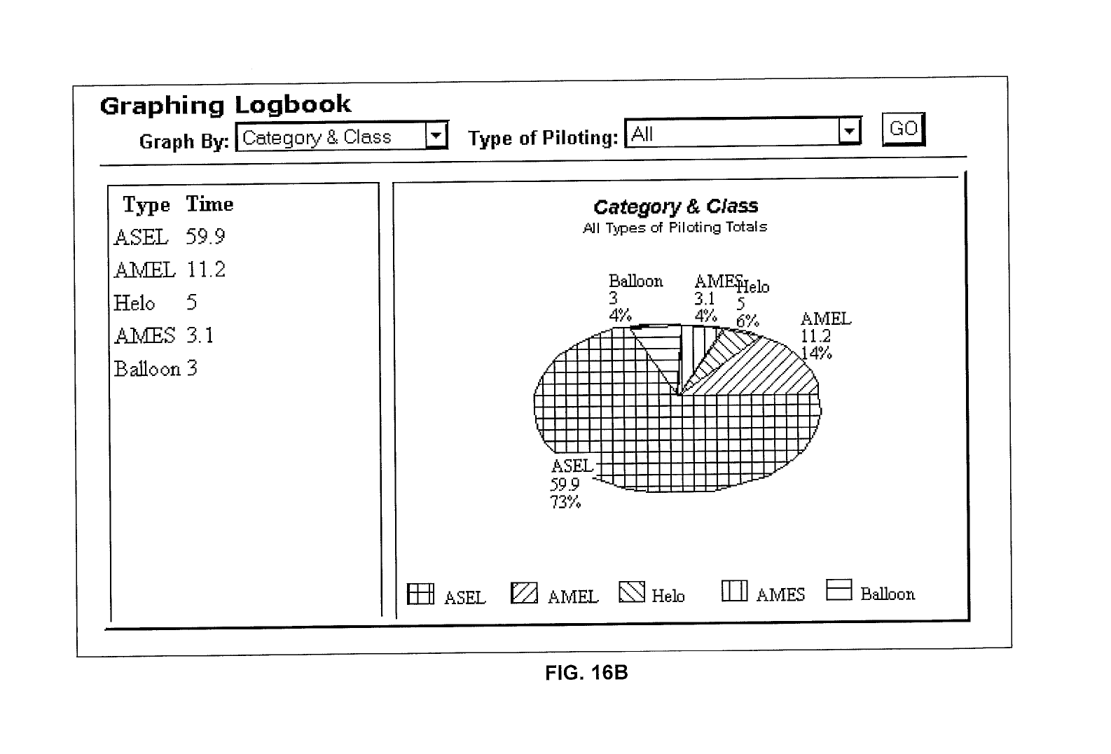

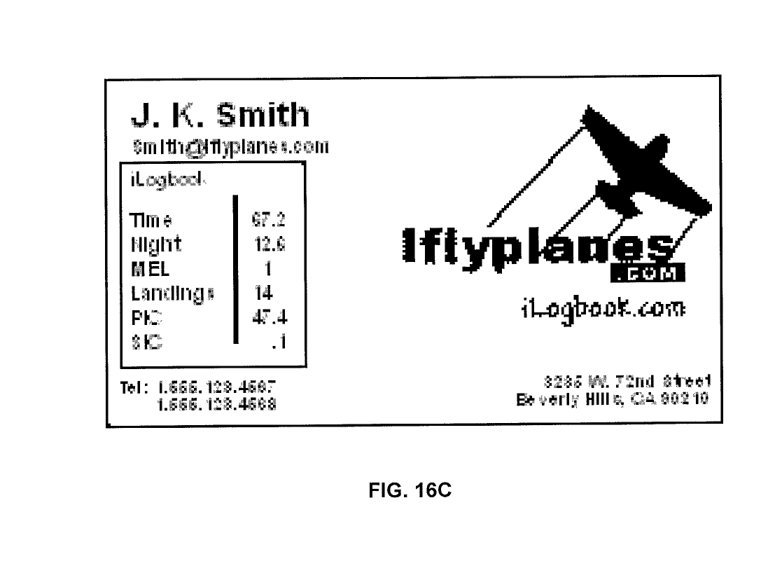

According to a preferred embodiment of the present invention, Report Logbook 6 preferably allows User 100, Authorized Entity 101, Authoritative Entity 103, Signing Entity 104 and System Administrator 102 to build, print and transfer electronically various Reports based on the logbook data. Preferably, these reports can be forms, graphs, or reports that are built from the logbook data. Presented in FIGS. 16A-16B are preferred web page implementations of part of Report Logbook 6. For example, in FIG. 16A, FAA Form 8710 is preferably automatically generated from logbook totals when it is created. This form is required when a pilot applies for a new certificate or an addition to existing certificate. A graphic representation of logbook totals is illustrated in FIG. 16B. As shown in FIG. 16C business cards can preferably be created from the logbook totals.

Further, according to a preferred embodiment of the present invention, the Reports that can be built from the various users and logbook data are numerous and may be greatly extended from the examples given here.

According to a preferred embodiment of the present invention, Communication of Uses 8 can preferably be used by any of the communicating actors 100, 101, 102, 103, 104 or 105. This Communication of Uses 8 preferably represents any of these use cases in FIG. 2 being communicated by any of the actors (100,101,102,103,104 or 105) in any local area network (LAN) or a wide area network (WAN), or connected through a radio transmitter/receiver (wireless) connection to a LAN or WAN, which is in turn preferably connected to the server system that implements these use cases. Administer System 5 preferably allows this system to be administered by a System Administer 102 or by a System 105. These administration functions may include defining security levels and access rights and privileges for authorized entities and users. System Administer 102 or System 105 may also permit authoritative entities access to specific portions of the data. In addition, Administer System 5 will preferably perform those tasks that are necessary to save, preserve, archive, backup, and restore the data and system. The logbook can preferably be Viewed 7 by the User 100, Authorized Entity 101, Authoritative Entity 103 or Signing Entity 104, and preferably has the capability to allow these actors to have preferences for Select Information 7.2 and Format Time 7.1. This arrangement embodies herein permitting at least one authoritative entity, related to such at least one specified regulated area of such at least one specified geo-political area, at least partial access to such stored required logbook information. This arrangement embodies herein at least one computer interface system structured and arranged to selectively control access to such individual logbook information by such at least one second user; at least one computer interface system structured and arranged to selectively grant access privileges to such at least one second user; and at least computer processor system structured and arranged to selectively restrict such access privileges of such at least one second user to at least one particular portion of such individual logbook information. This arrangement embodies herein computer-assisting selectively controlling access to such individual logbook information by such at least one second user; computer-assisting selectively granting access privileges to such at least one second user; and computer-assisting selectively restricting such access privileges of such at least one second user to at least one particular portion of such individual logbook information.

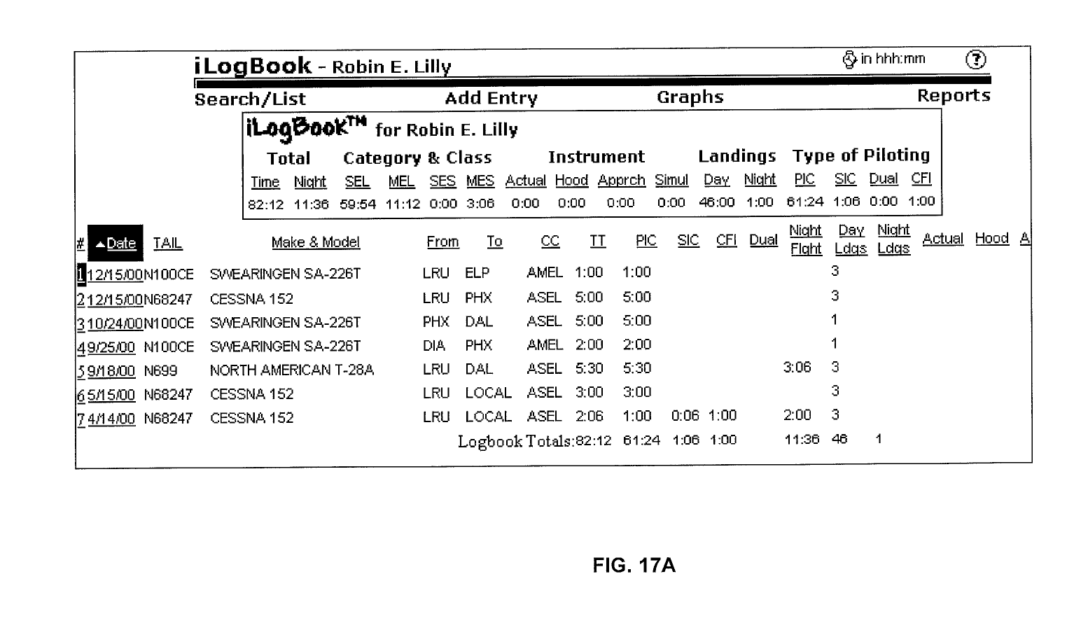

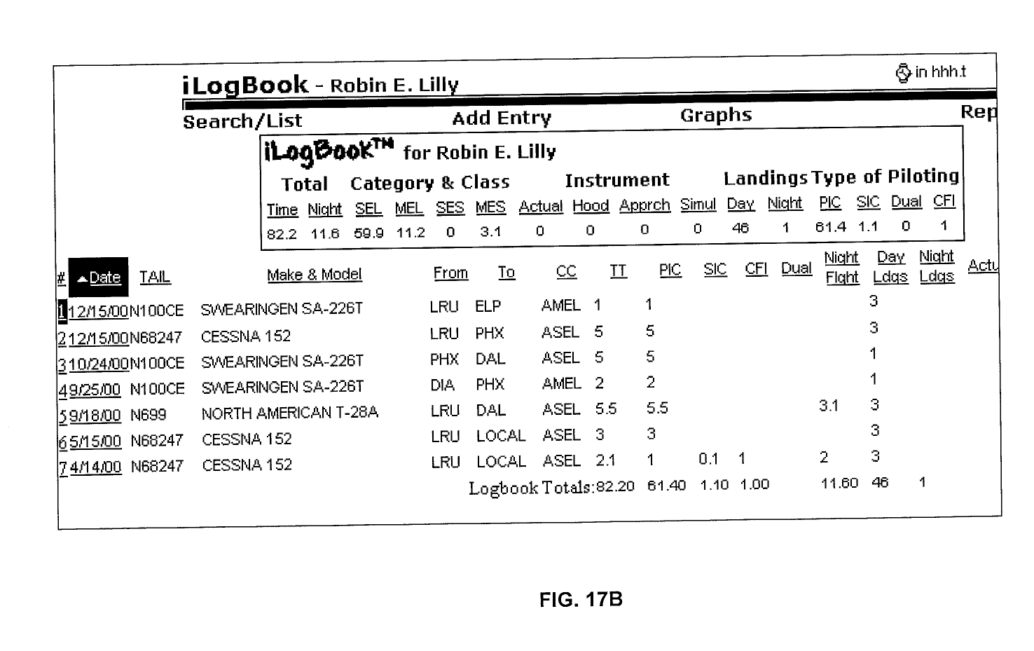

According to a preferred embodiment of the present invention, the actor (100,101,103,104) is preferably able to select to have time data displayed in a format of Hours followed by Minutes (hhh:mm), or is preferably able to switch the format of time to be in a format of Hours followed by Tenths of a minute (hhh.t). An aviation web page implementation of the Format of Time is shown in FIGS. 17A-17B. Preferably, the system may format time data in any valid time format necessary to communicate to the actors and system the information that is appropriate.

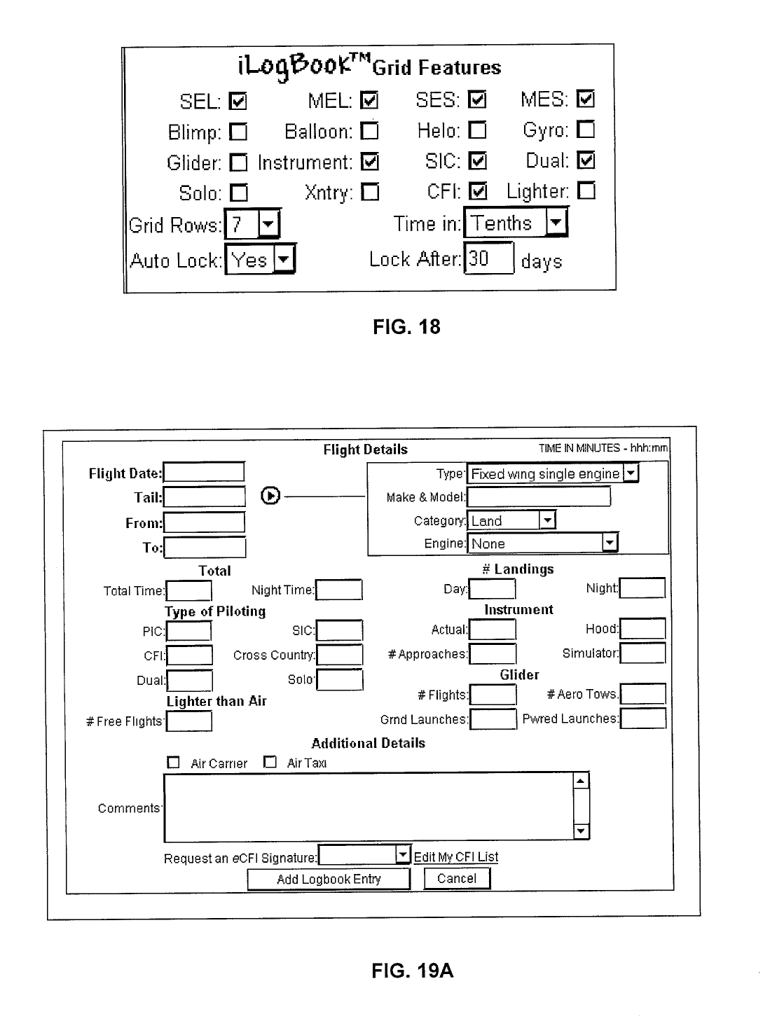

As shown in FIG. 18, a web page implementation of Select Information 7.2 where specific fields, such as Second-In-Command (SIC), Aircraft Single Engine Land (SEL), Aircraft Multi-Engine Land (MEL), Single Engine Sea (SES), Multi-Engine Sea (MES), Blimp, Balloon, Helicopter (Helo), Gyrocopter (Gyro), Glider, Instrument, Dual-Instruction-Received (Dual), Solo Flight Time (Solo), Cross-Country (Xntry), Certified Flight Instructor (CFI), and Lighter-than-Air (Lighter), the number of rows to display, Time before locking the data, are preferably all able to be selected and affect Logbook View 7. This arrangement embodies herein permitting selective authorization, by such at least one authoritative entity, for such at least one user, from respective client stations, to send selective information relating to such logbook information to such at least one Internet server; and permitting access by such at least one user to such selective information. This arrangement embodies herein at least one computer interface system structured and arranged to set the selection criteria by at least one such second user from such individual logbook information; at least one computer processor system structured and arranged to select a set of such individual logbook information; and at least one computer interface system structured and arranged to present at least one such set of such individual logbook information for viewing by at least one such second user. This arrangement embodies herein computer-assisting setting the selection criteria by at least one such second user from such individual logbook information; computer-assisting selecting a set of such individual logbook information; and computer-assisting presenting a at least one such set of such individual logbook information for viewing by at least one such second user.

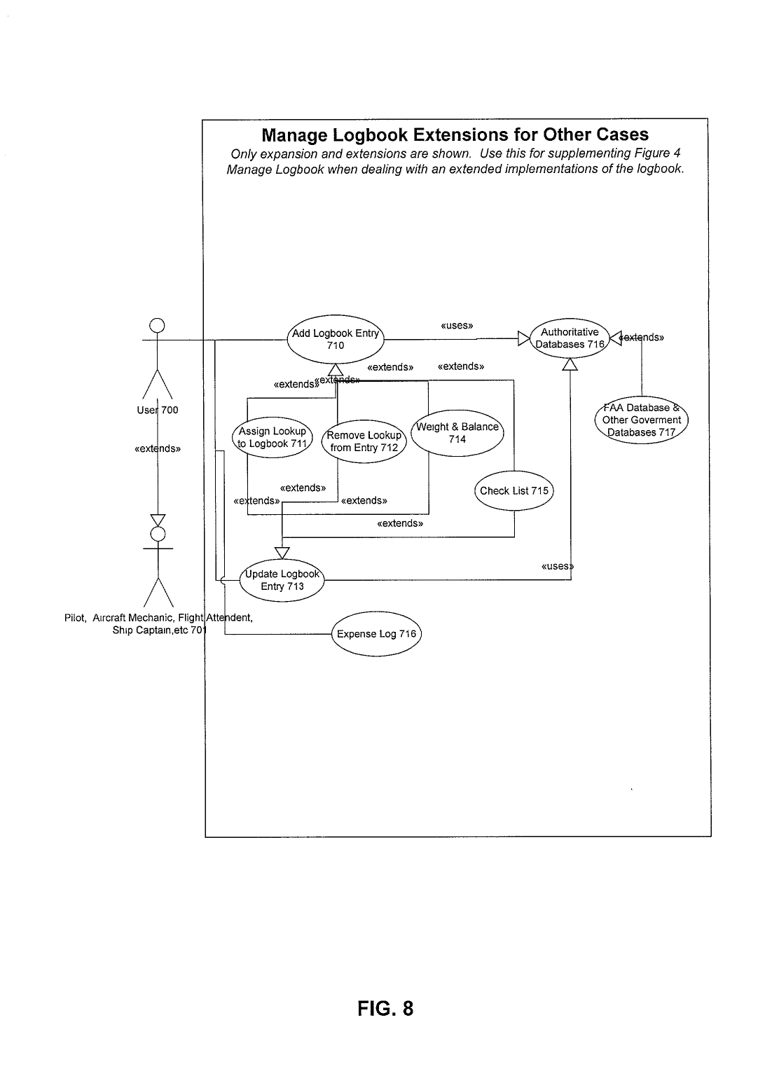

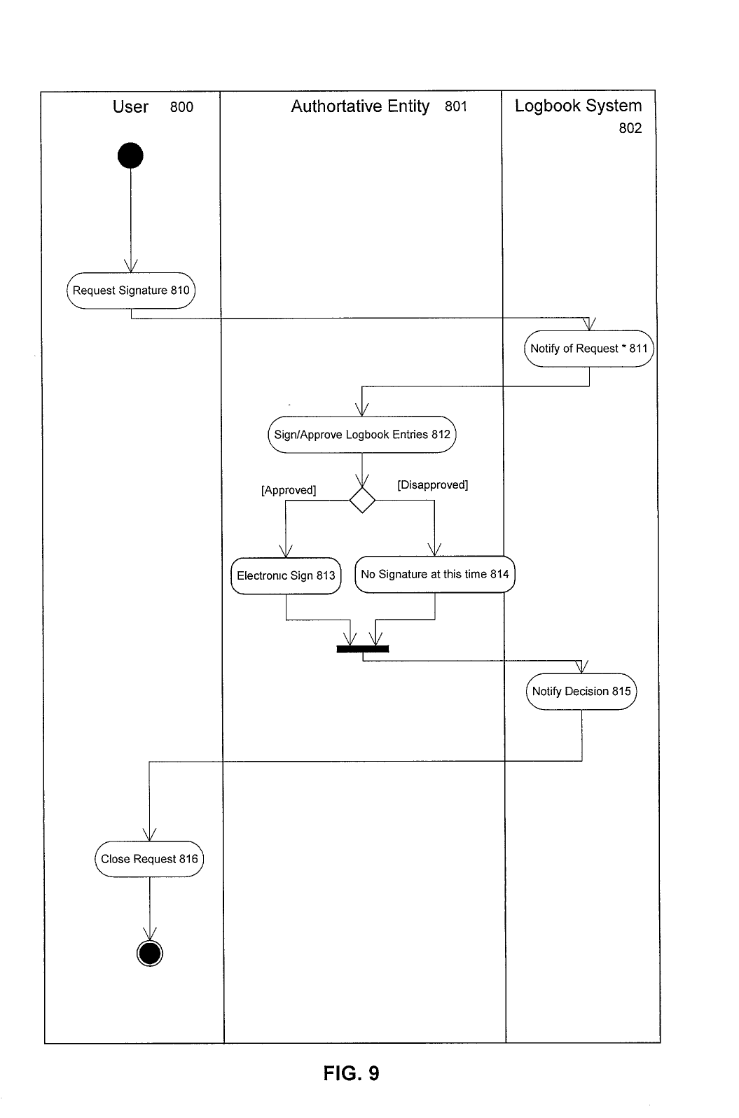

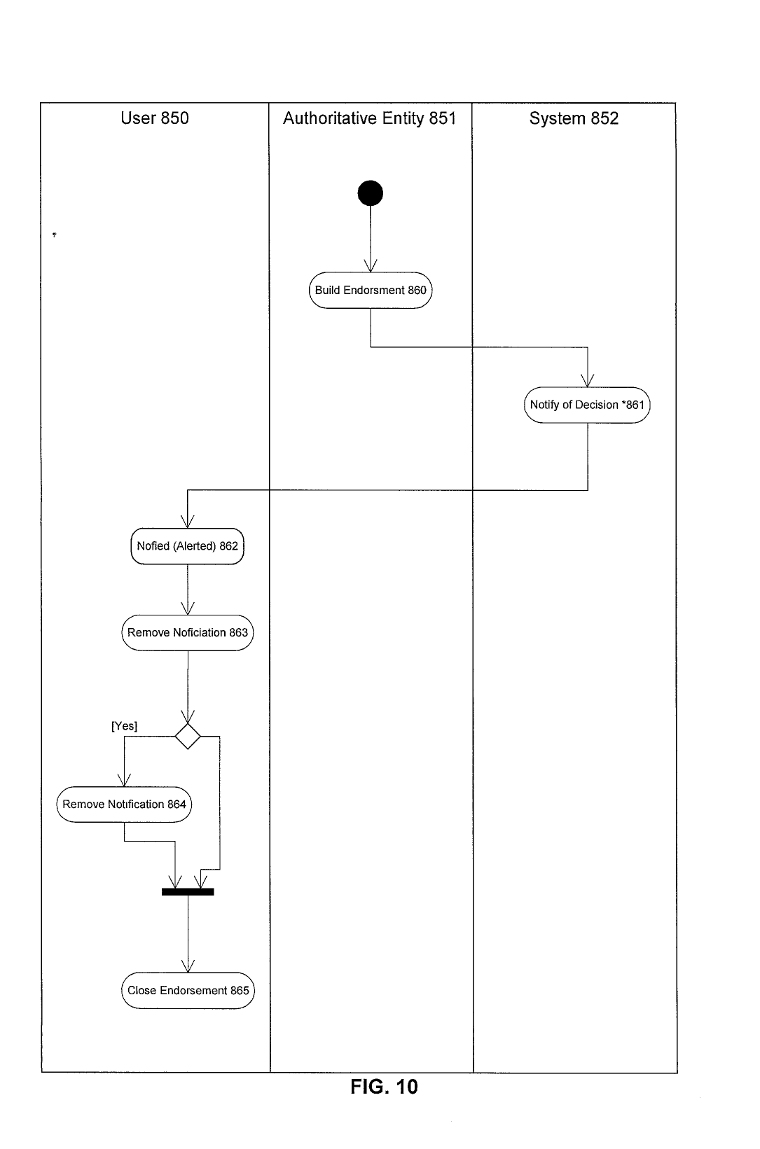

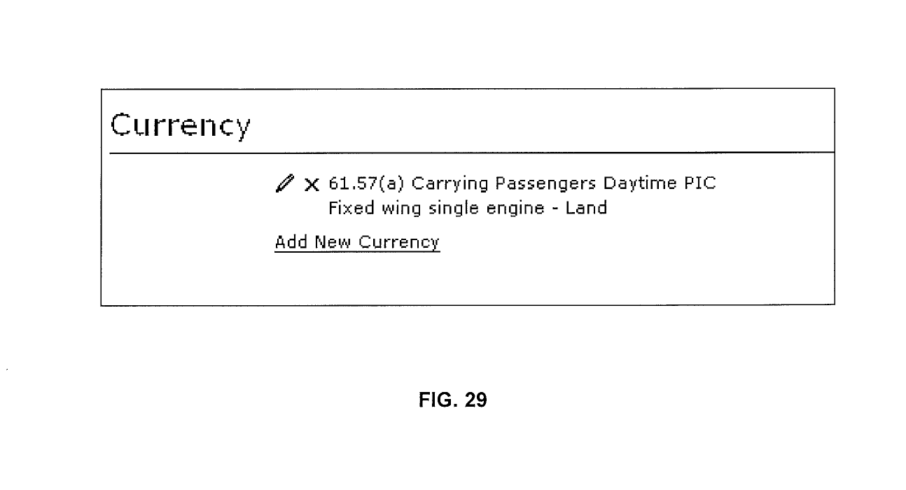

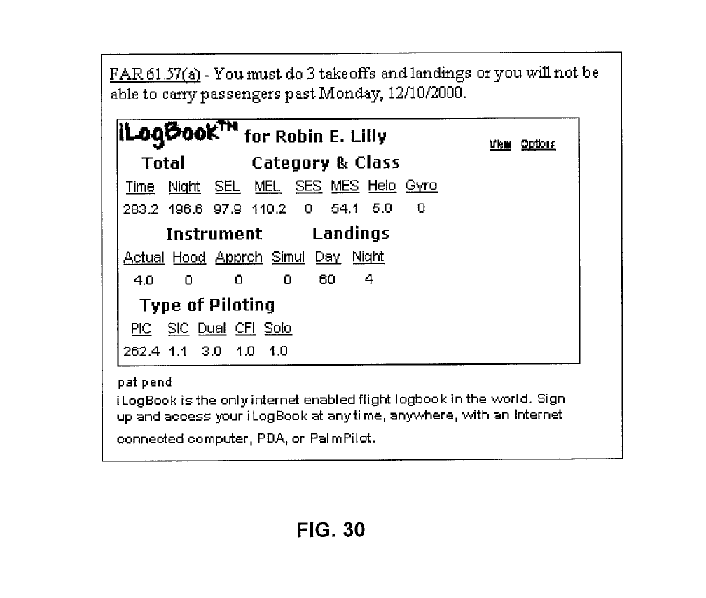

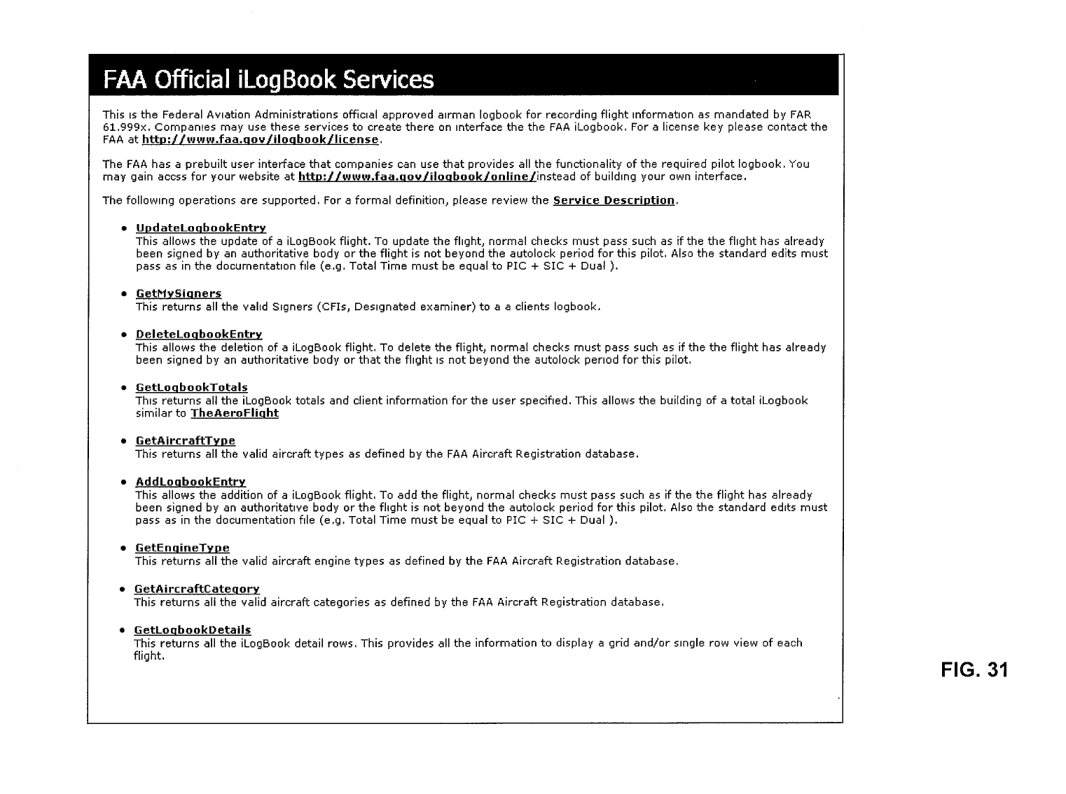

According to a preferred embodiment of the present invention, Alerts 50 can preferably be delivered to multiple locations, wherever the entity (actor 100,101,102,103,104, or 105) desires the alert to be delivered. An aviation HTML web page implementation of a Currency Alert 50.1 is shown with FIGS. 29 and 30. As shown in FIG. 29 and FIG.30, as requested by User 100, a currency alert is preferably generated, and the User 100 is notified, when the pilot is not in compliance with Federal Aviation Regulation (FAR) 61.57 regarding the carrying of passengers in the daytime in a fixed wing single engine land aircraft. This currency alert, as shown in FIG.30, shows that the pilot would not be eligible to carry passengers past the date shown unless the pilot completed 3 takeoffs and 3 landings. Failure of the pilot to be in compliance with the FAR would cause the pilot to be in violation of the federal regulation. The alerts can preferably manifest themselves in many ways including the “Notification of Request for electronic signature” 811, “Notify Decision” 815 as shown in FIG. 9 or the “Notify of Decision” 861 as shown in FIG. 10.

According to a preferred embodiment of the present invention, logbook details may preferably be embedded in Electronic documents, as shown in FIG. 3. User 200 preferably creates Embedded Document 210 in the logbook. Management Resume 213 preferably extends embedded Document 210. User 200 preferably updates Embedded Document 212 or Removes Embedded Document 211, which are both preferably extended by Manage Resume 213. User 200 preferably views the Embedded Document 214 that is extended by Review Resume 216. The View Document 214 preferably uses View Logbook 215. User Authorized Entity 202 also preferably Views the Embedded Document 214 that is preferably extended by Review Resume 216. The View Document 214 preferably uses View Logbook 215. Embedded Documents preferably provide the capability for the user to embed records from the logbook into electronic documents that are separate from the logbook. User 200, by extension, is User 201, a pilot, truck driver, mariner or other person who would preferably record activities or actions in a logbook and then preferably embed the logbook information into an electronic document, such as an HTML web page resume.

This arrangement embodies herein permitting embedding of such logbook information directly into other electronic documents where all combined document details, both those from such logbook information and such other original documents, can be analyzed. This arrangement embodies herein at least one computer processor system structured and arranged to combine such individual logbook information directly with other electronic documents to form a combined document; at least one computer processor system structured and arranged to analyze at least one such combined document details; and at least one computer interface system structured and arranged to present results of such analysis to at least one such second user. This arrangement embodies herein computer-assisting combining such individual logbook information directly with other electronic documents to form a combined document; computer-assisting analyzing at least one such combined document details; and computer-assisting presenting results of such analyzing to at least one such second user.

According to a preferred embodiment of the present invention, presentation of logbook details embedded in a resume, a search facility for finding individuals and the results of using the search facility are preferably extensions of the implementation Review Resume 216 and Resume 2.1. As shown in FIG. 13A, the summarized logbook details are preferably embedded as part of the resume details shown on the page. As shown in FIG. 13B, a search facility is used to locate a specific individual's information by the details contained in the individual's logbook. As shown in FIG. 13C, the results of the search preferably identify those individuals whose specific logbook information matched the search criteria entered in FIG. 13B. Those skilled in the art will readily appreciate that the embedded logbook has, under appropriate circumstances, uses and implications that exceed those shown in the attached figures and within comments. Logbook details, summarized or not, can be embedded in a multitude of electronic documents, such as email messages where the most up-to-date log information is required. Personal logbook information can be viewed, as shown in FIG. 13A, and added, updated and deleted as shown in FIG. 14B, with all changes immediately being reflected in the resume or other embedded documents.

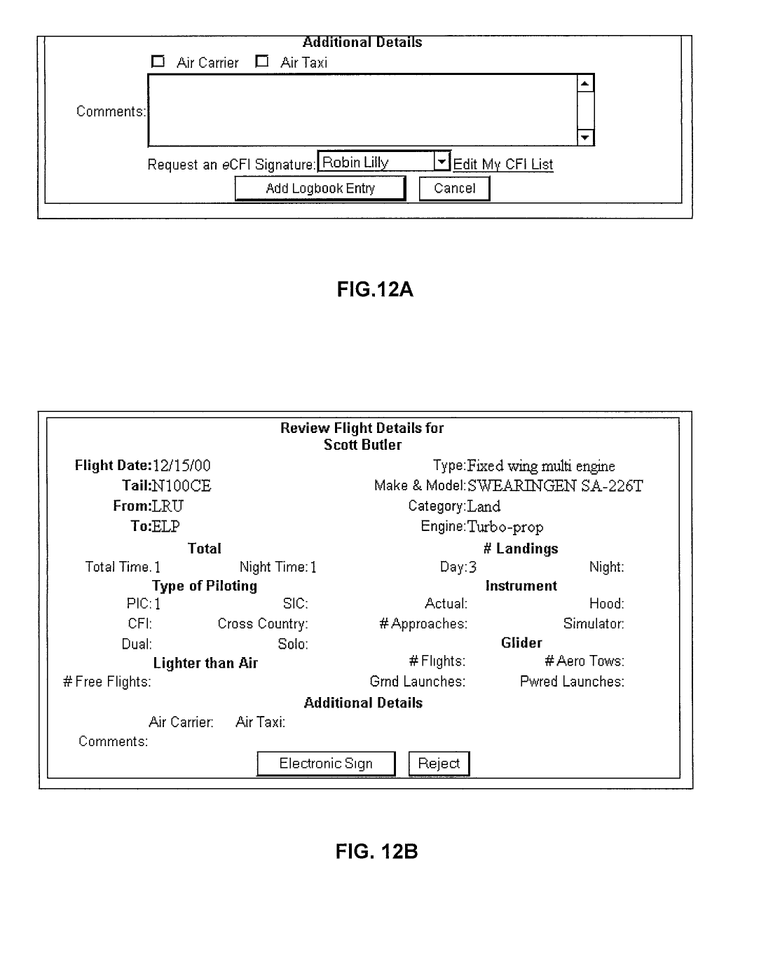

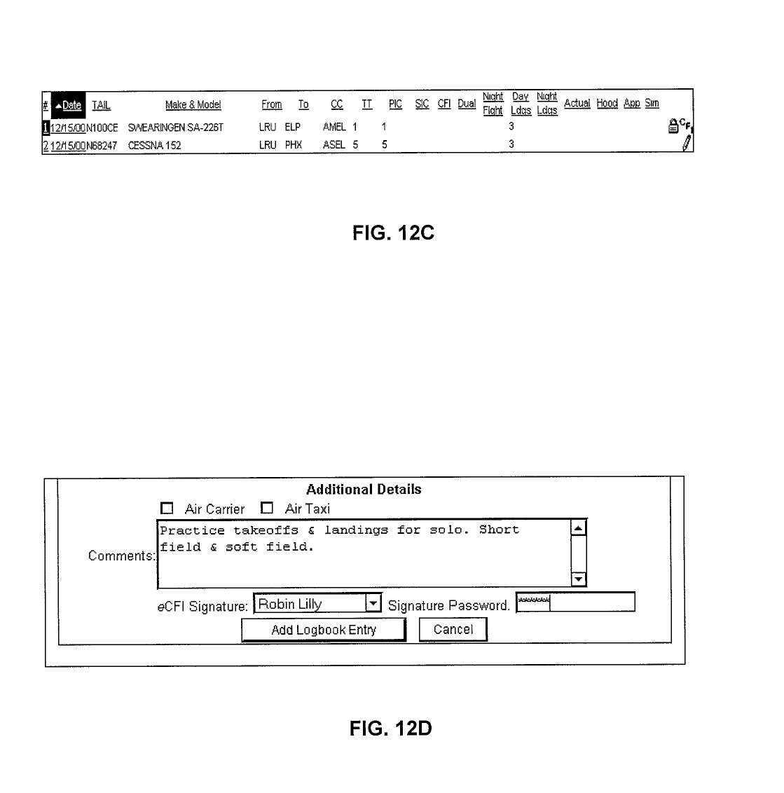

According to a preferred embodiment of the present invention, the logbook application preferably provides a method by which the authoritative entity is notified of the existence of flight log records that must be reviewed; the examiner preferably reviews the logbook and electronically signs the record following the review; and once electronically signed, preferably the record cannot be modified unless the original signer approves the modification. As shown in FIG. 4, User 300, who by extension is a pilot, truck driver, mariner, or other person who uses the logbook, preferably requests a signature, as shown in FIG. 12A, of the logbook by an Authoritative Entity 302, who is the Signing Entity 303 by extension. Also as shown in FIG. 4, the Authoritative Entity 303 preferably uses Notify Request, and uses Sign or Approve logbook as illustrated in FIG. 12B. Also as shown in FIG. 4, the Authoritative Entity 302 can preferably initiate an endorsement by Endorse Logbook 314 and the Authoritative Entity 303 preferably notifies the User 300 using Notify Signed 312. In the case of an aircraft pilot, the pilot's record of flights is, by FAA regulation, required to be reviewed by an FAA examiner.

Further, in a preferred embodiment of the present invention, this logbook system demonstrates how, in the case of an aircraft pilot, that pilot's records can be endorsed by the initiation of the Authoritative Entity 303 creating an endorsement. As shown in FIG. 28, signed endorsements are preferably not tied to logbook records, but rather the User's 100 logbook as a whole. As shown in FIGS. 25A-25C, various endorsement possibilities for pilots are preferably supported by the system.

One skilled in the art will appreciate that many applications of this invention exist wherein an authoritative entity may be required to review and sign off on activities recorded in activity logs. The use of the electronic signature can be carried across industry and education, where review and proof of review, such as an electronic signature, is required. And storage of such authorizations along with the log entries at a secure Internet location is of great benefit to all the interested parties.

According to a preferred embodiment of the present invention, Manage Logbook processes preferably provide the capability for the user to maintain his/her logbook in an electronic format. As shown in FIG. 5, User 400 who, by extension, is User 401—a pilot, truck driver, mariner, or other person who would preferably manage the activities or actions in a logbook, can View 418, Add 411, Remove 412, or Update Logbook Entries 415. Preferably, the View 418, Add 411, and Update Logbook Entries 415 are used in the Authoritative Database 413. The User 400, View Logbook Entries 418, Update Logbook Entries 415, and Remove Logbook Entries 412 are preferably able to use Find Logbook Entries 414. Add Logbook Entries 411 is preferably extended with Default Values 410. User 400 can preferably Sort Logbook 416 or Filter the Logbook 426. User 400 and Logbook View 418 can preferably use Summarized Entries 417. Logbook View 418 is preferably extended by Format Time 419 and Select Information 420. User 400 can preferably Manage Client Information 425. User 400 can preferably Add 421, Update 423, and Remove Electronic Signers 424 of the logbook. Update Electronic Signers 423 and Remove Electronic Signers 424 can preferably use Find Signee 422. One skilled in the art will appreciate that these various use cases can preferably be omitted, rearranged or adapted in various ways in appropriate circumstances.

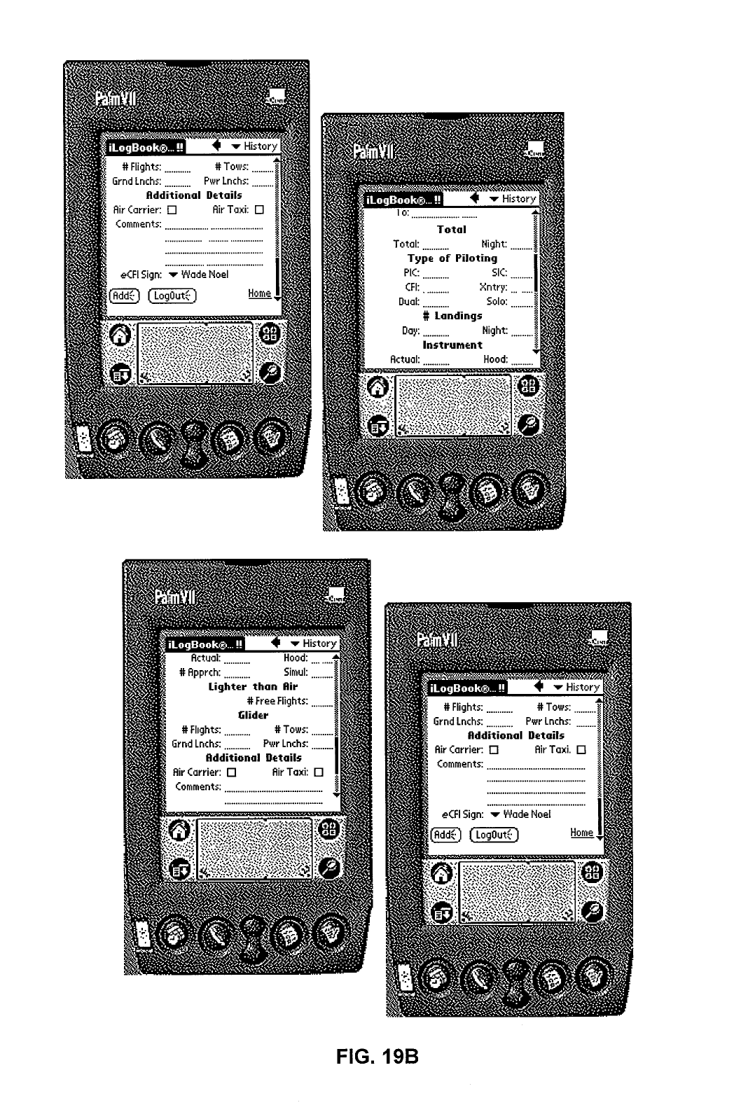

In a preferred embodiment of the present invention, User 400 can preferably maintain his/her logbook by Adding 411, Removing 412, or Updating Logbook Entries 415. As shown in FIG. 19A, the Flight Details page provides the ability to input all required flight information of the Add Logbook Entry 411. The logbook of User 400 (Add Logbook Entry 411, Update Logbook Entry 415) can preferably be tied directly to Authoritative Databases 413, such as the Federal Aviation Administration (FAA) Airmen table, an FAA Aircraft Reference table, or other related tables.

Preferably, when a User 400 adds a Logbook Entry 411, the user can specify to have Defaults 410 enabled that set specified value(s) into selected fields, as shown in FIGS. 19A-19B. As shown in FIG. 1 9B the input and presentation of logbook information can be supported using handheld devices operating either in stand-alone or wireless mode. This arrangement embodies herein implementing inputting such logbook information using at least one stand-alone device; implementing storing such inputted logbook information on such at least one stand-alone device; implementing transmitting such stored logbook information from such at least one stand-alone device to at least one local area network; implementing transmitting such stored logbook information from such at least one stand-alone device to at least one wide area network; and implementing storing such transmitted logbook information in such unified database system. This arrangement embodies herein implementing transmitting such logbook information of such at least one user to such at least one stand-alone device from such at least one local area network; implementing transmitting such logbook information of such at least one user to such at least one stand-alone device from such at least one wide area network; implementing storing such logbook information on such at least one stand-alone device; and implementing displaying such logbook information stored on such at least one stand-alone device to such at least one user. This arrangement embodies herein implementing inputting such logbook information on at least one wireless device; implementing storing such inputted logbook information on such at least one wireless device; implementing transmitting such stored logbook information from such at least one wireless device to at least one local area network; implementing transmitting such stored logbook information from such at least one wireless device to at least one wide area network; and implementing storing such transmitted logbook information in such unified database system. This arrangement embodies herein implementing transmitting such logbook information of such at least one user to such at least one wireless device from such at least one local area network; implementing transmitting such logbook information of such at least one user to such at least one wireless device from such at least one wide area network; implementing storing such logbook information on such at least one wireless device; and implementing displaying such logbook information stored on such at least one wireless device to such at least one user. This arrangement embodies herein at least one computer interface system structured and arranged to input such individual logbook information using at least one stand-alone device; at least one computer processor system structured and arranged to store such inputted such individual logbook information on such at least one stand-alone device; and at least one computer transmitter system structured and arranged to transmit such individual logbook information from at least one such stand-alone device to such unified database system. This arrangement embodies herein at least one computer transmitter system structured and arranged to transmit such individual logbook information from at least one such unified database system to at least one such stand-alone device; at least one computer processor system for storing such transmitted such logbook information on such at least one stand-alone device; and at least one computer interface system structured and arranged to present at least one such set of such individual logbook information using at least one stand-alone device for viewing by at least one such second user. This arrangement embodies herein at least one computer transmitter system structured and arranged to transmit such individual logbook information from at least one such unified database system to at least one such stand-alone device; at least one computer processor system for storing such transmitted such logbook information on such at least one stand-alone device; and at least one computer interface system structured and arranged to present at least one such set of such individual logbook information using at least one stand-alone device for viewing by at least one such second user. This arrangement embodies herein computer-assisting inputting such individual logbook information using at least one stand-alone device; computer-assisting storing such inputted individual logbook information on such at least one stand-alone device; and computer-assisting transmitting such stored individual logbook information from at least one such stand-alone device to such unified database system. This arrangement embodies herein computer-assisting transmitting such individual logbook information from at least one such unified database system to at least one such stand-alone device; computer-assisting storing such transmitted such logbook information on such at least one stand-alone device; and computer-assisting presenting at least one such set of stored individual logbook information using at least one such stand-alone device for viewing by at least one such second user. This arrangement embodies herein computer-assisting inputting such individual logbook information using at least one wireless device; computer-assisting storing such inputted individual logbook information on such wireless device; and computer-assisting transmitting such stored individual logbook information from at least one such wireless device to such unified database system. This arrangement embodies herein computer-assisting transmitting such individual logbook information from at least one such unified database system to at least one such wireless device; computer-assisting storing such transmitted such logbook information on such at least one wireless device; and computer-assisting presenting at least one such set of such individual logbook information using at least one wireless device for viewing by at least one such second user.

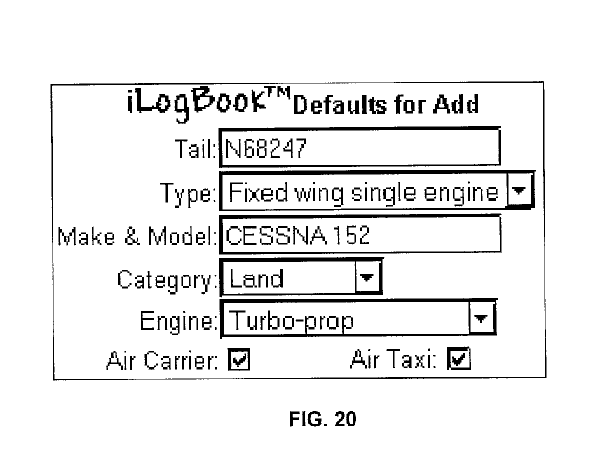

As shown in FIG. 20, User 400 has preferably specified the default values such that when User 400 loads the Add Logbook Entry 411 window, the default values preferably appear in the appropriate fields. The User 400, Authorized Entity 402, System Administrator 403, Authoritative Entity 404 can preferably Filter 426, Sort 416, or Summarize 417 the Logbook Entries in any necessary or desired fashion.

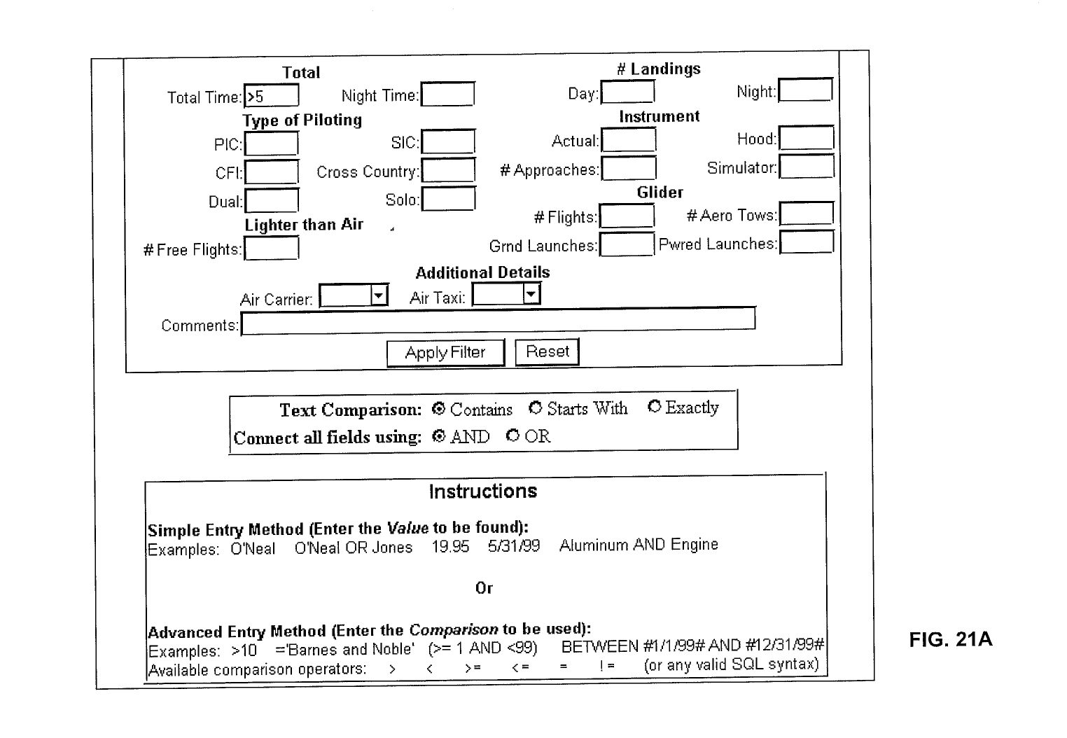

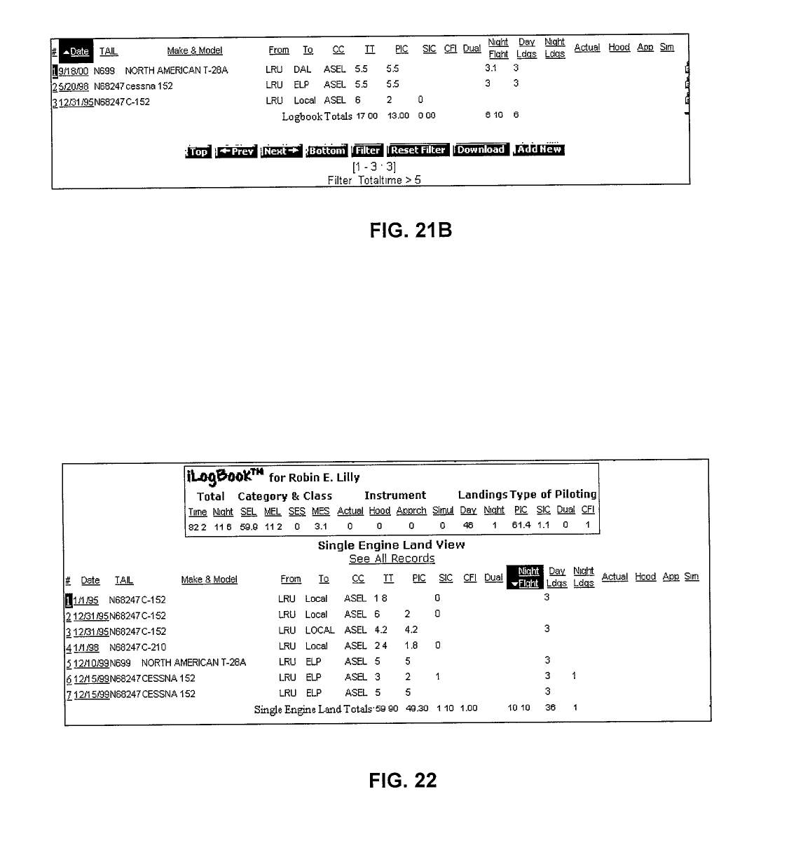

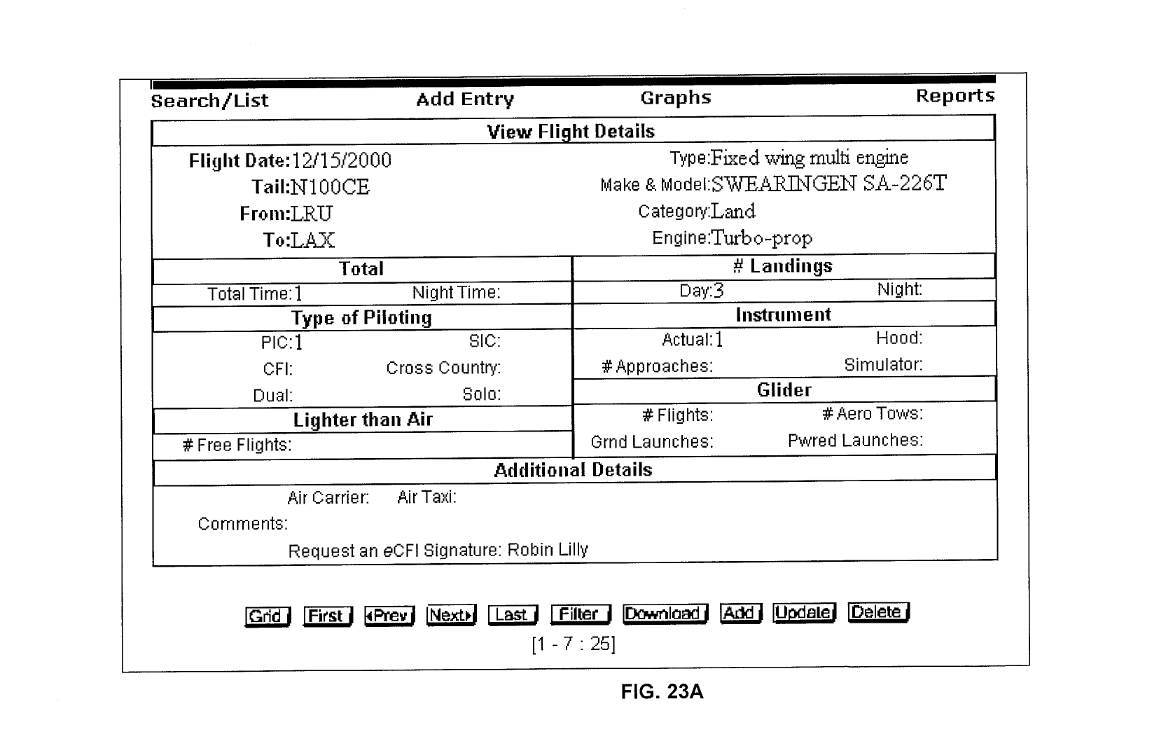

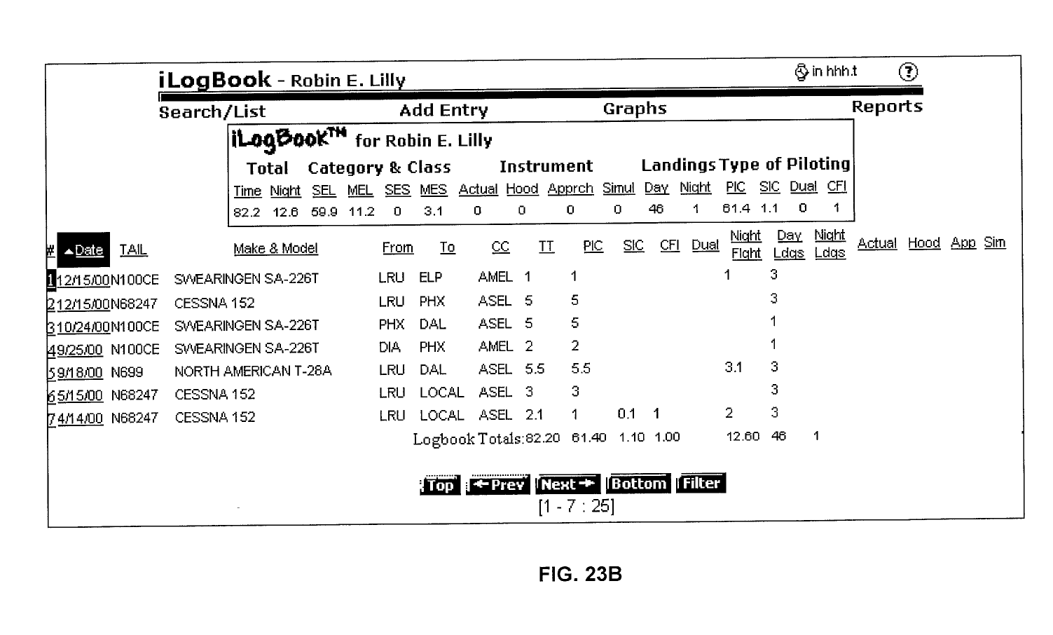

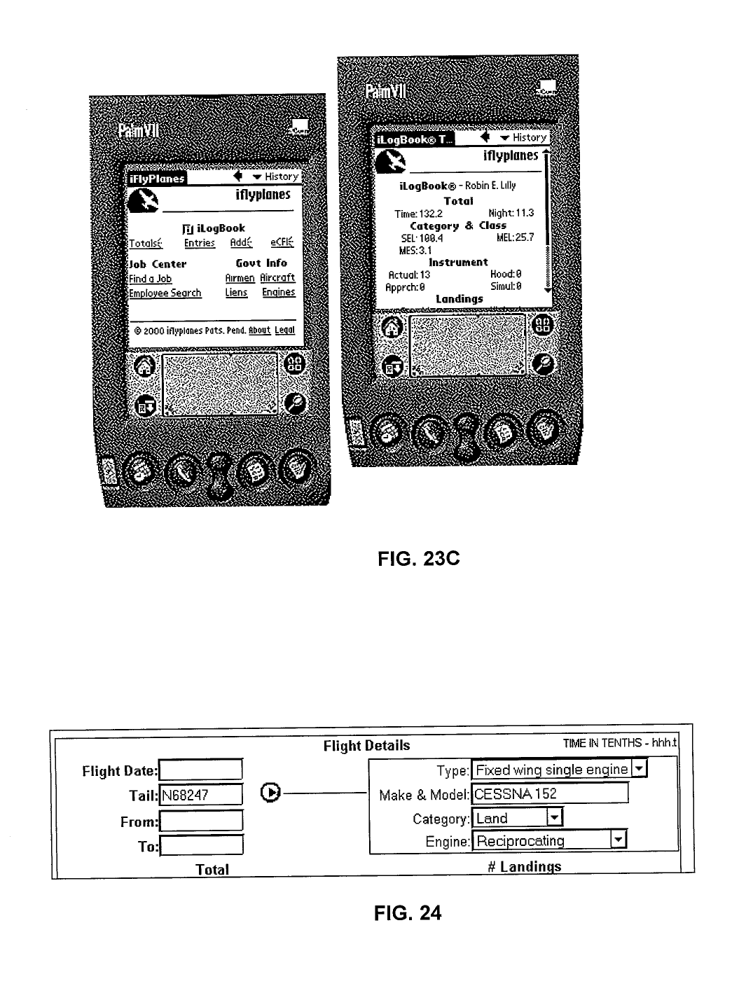

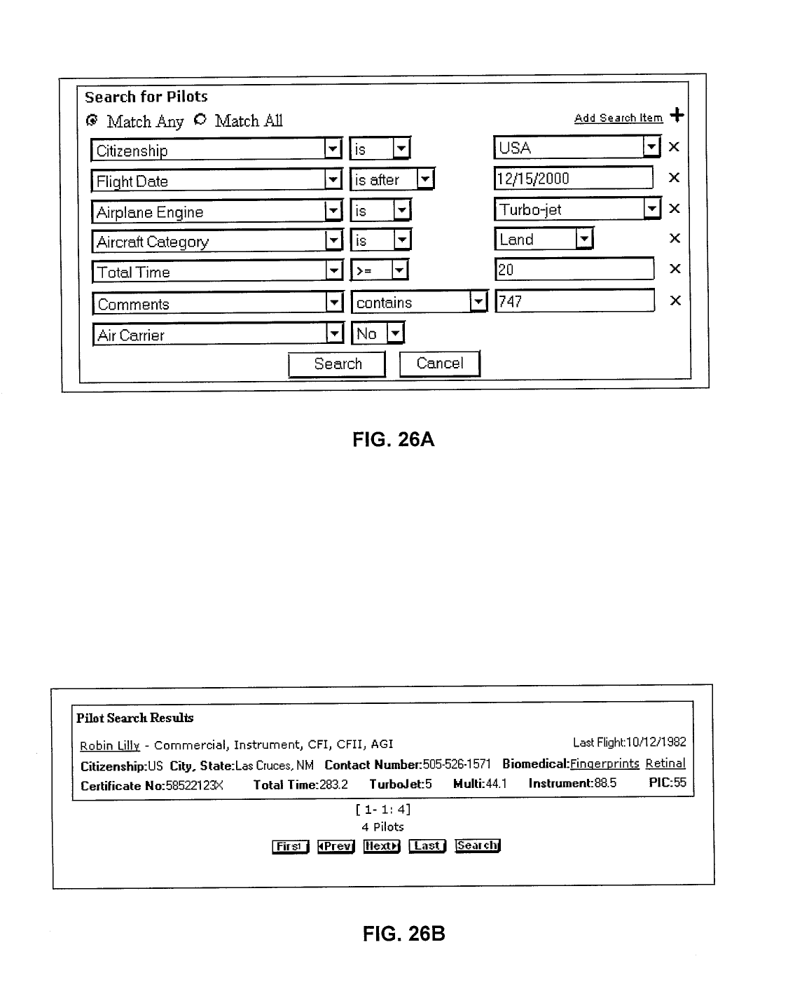

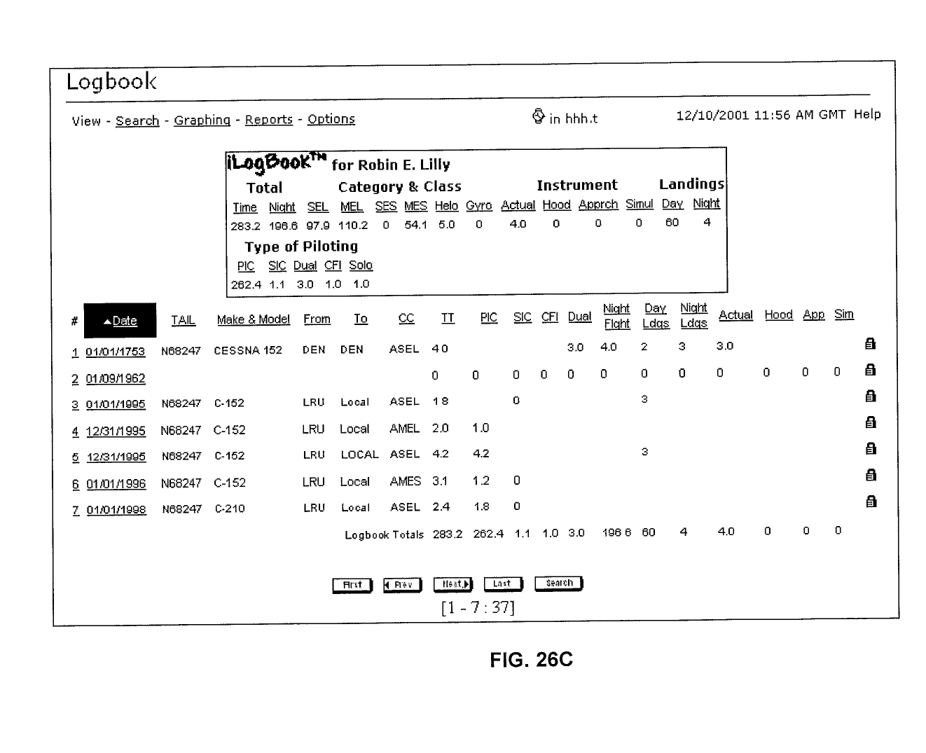

As shown in FIGS. 21A-21B User 400 preferably selects a filter to narrow the results in a Logbook View 418 result list. Additionally, as shown in FIG. 22 Filter 426 is preferably displayed with the Summarized Entries 417. Further, as shown in FIGS. 26A-26C the Authoritative Entity 402 may preferably narrow the search results and display the Logbook View 418. As shown in FIG. 26A the Authoritative Entity 402 preferably searches to narrow the results. As shown in FIG. 26B the results have been limited to the criteria shown in FIG. 26A. As shown in FIG. 26C resulting pilot logbooks can then be preferably shown in a Logbook View 418. The Logbook can preferably be Viewed 418 by the User 400, Authorized Entity 402, System Administrator 403, or Authoritative Entity 404 while allowing User 400, Authorized Entity 402, System Administrator 403, or Authoritative Entity 404 to have preferences for Select Information 420 and Format Time 419. As shown in FIGS. 17A-17B User 400 is preferably able to select a time data display in a format of hours followed by minutes (hhh:mm) or is able to switch the format of time display to hours followed by tenths of a minute (hhh.t). This is one example specifically related to aviation, but does not preclude the system from formatting logbook time data in any valid time format that is necessary to communicate to the actors and system the information that is appropriate to any other embodiment of this invention.

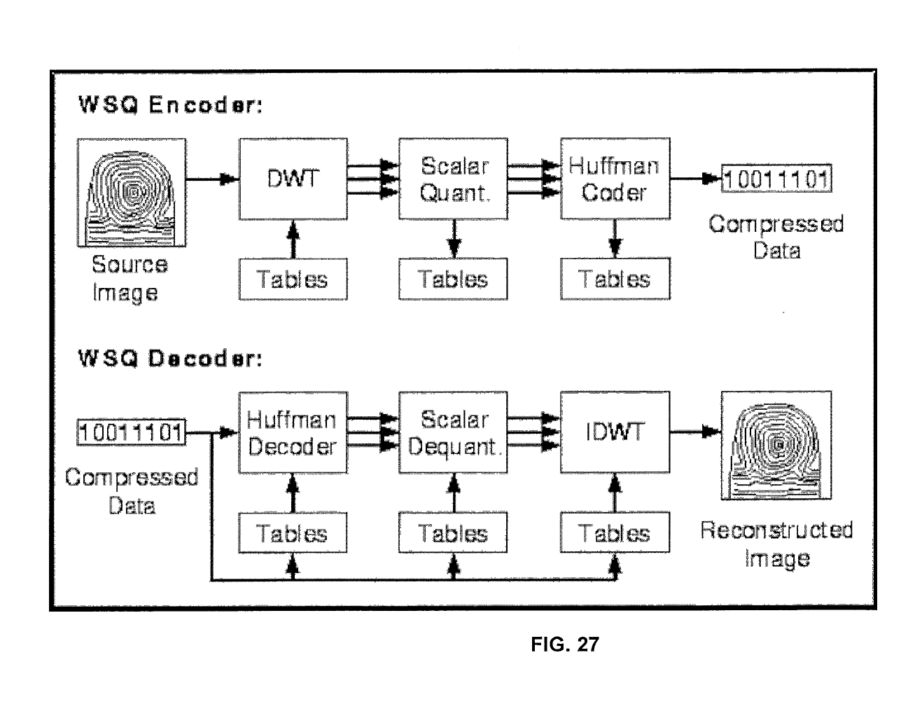

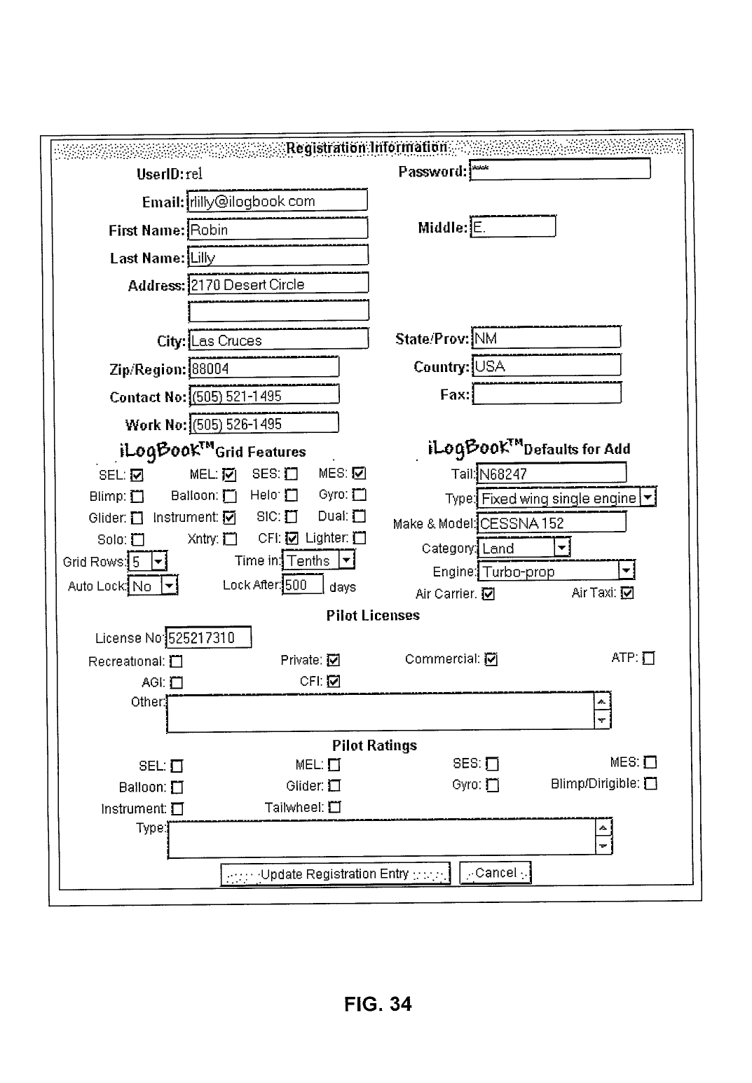

According to a preferred embodiment of the present invention, User 400, Authorized Entity 402, System Administrator 403, or Authoritative Entity 404 can preferably manage the Client Information 425. This management of the client information includes all of the details necessary about User 400, Authorized Entity 402, System Administrator 403, or Authoritative Entity 404 to maintain the system. As shown in FIG. 34 these details would preferably include data such as name, address, phone, e-mail address, etc. Preferably, additional detailed information, such as Citizenship, Visa Type, Student Type, passwords & Unique User identification information, Biomedical information (e.g. Fingerprints, Retinal Scans, or Palm Prints), photographs of the Logbook Owner, Drivers License Numbers, Certificate Numbers, Types of Licenses and Type Ratings held (CFI, CFII, Commercial, Instrument) are stored. Also stored preferably is medical information including License & Expirations (Class I, II, III and Expires Date, Physician), and detailed personal medical history of the logbook owner. The logbook system data can also preferably be separated by the authoritative entity. For example, in the aviation field, the FAA could preferably mandate through Manage Client Information 425, that the pilot maintains the flight records and address, while the FBI maintains the biomedical information relating to the pilot. Preferably, the pilot's medical examiner maintains the pilot's Medical Certificate information for the pilot, while the FAA maintains the types of Licenses held for the pilot. Preferably, biomedical Information may use the current authoritative entity's compression and searching technology for distribution of the data, such as the FBI's Wavelet/Scalar Quantization (FBI WSQ) Specification for compression of digitized gray-scale fingerprint images, which is shown in FIG. 27. The Authoritative Entity 404 can preferably gather biomedical information such as fingerprints in various ways. The Authoritative Entity 404 may, with the assistance of local law enforcement, preferably obtain a fingerprint card from the User 400. That biomedical data for User 400 is then preferably input by an Authorized Entity 402, which has preferably been designated by Authoritative Entity 404. All information necessary, including information such as the Default Values 410 or Select Information 420 is preferably available in the system. Preferably the User 400 can Find 422, Add 421, Update 423, or Remove Electronic Signers 424. Thus, a user can preferably predetermine the parties who are able to sign the user's logbook at the user's discretion. This arrangement embodies herein permitting such at least one user, from respective user-input stations, to send respective data packets relating to respective demographic information to an Internet server; and storing in such unified database system such demographic information relating to such logbook information of such at least one user. This arrangement embodies herein permitting such at least one authoritative entity, from respective client stations, to send respective data packets relating to respective biomedical identification information for such at least one user to such at least one Internet server; and storing in such unified database system such biomedical identification information relating to such logbook information of such at least one user. This arrangement embodies herein permitting such at least one authoritative entity, from respective client stations, to send respective data packets relating to respective biomedical identification information for such at least one user to such at least one Internet server; and storing in such unified database system such biomedical identification information relating to such logbook information of such at least one user. One skilled in the art can appreciate that the features of Manage Logbook extend into many areas and fields beyond the aviation example used herein.

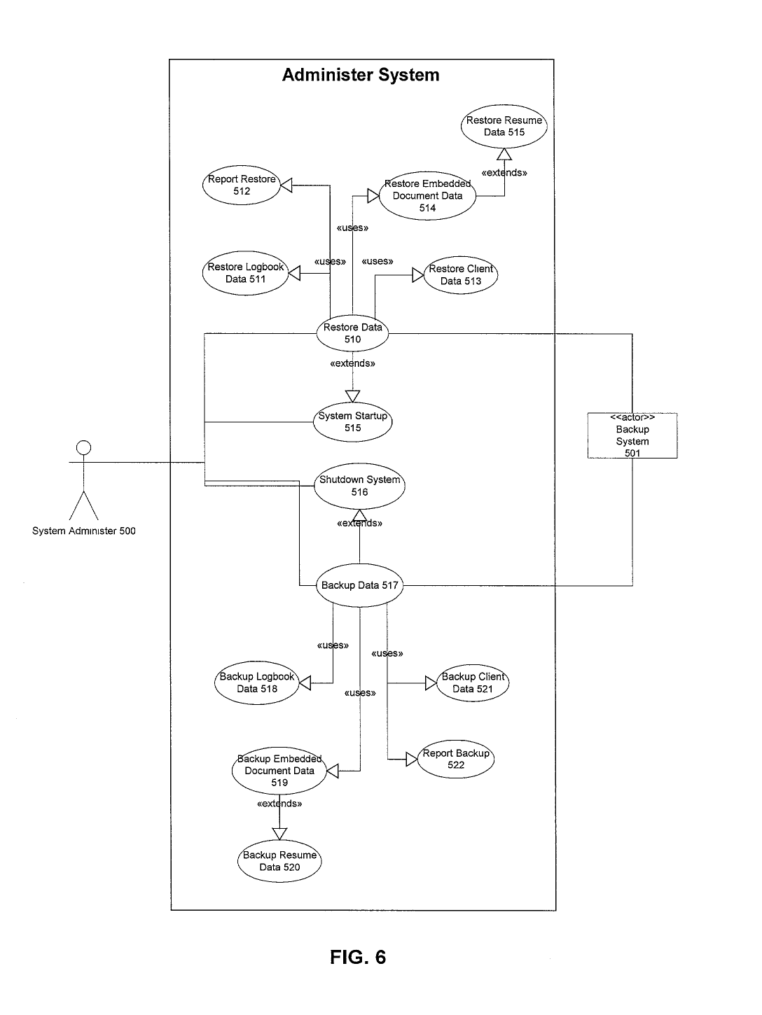

According to a preferred embodiment of the present invention, the Administer System is preferably the capability of the logbook system administrator to start the system when it has been shut down, backup all data contained in the system, restore all data as required, and shutdown the system for maintenance and other purposes. As shown in FIG. 6 the System Administrator 200 starting the logbook system with System Startup 515. System Startup 515 is preferably extended by Restore Data 510, which preferably uses Report Restore 512, Restore Logbook 511, Restore Client Data 513 and Restore Embedded Document Data 514. Restore Resume Data 515 preferably extends restore Embedded Document Data 514. The actor Backup System 501 preferably restores the system with Restore Data 510. System Administrator 500 preferably restores the system by Restore Data 510, which preferably uses Report Restore 512, Restore Logbook 511, Restore Client Data 513 and Restore Embedded Document Data 514. Restore Resume Data 515 preferably extends restore Embedded Document Data 514. Either System Administrator 500 or Backup System 501 preferably backs up data at Backup Data 517, which preferably uses Backup Logbook Data 518, Backup Client Data 521, Report Backup 522 and Backup Embedded Document Data 519. Backup Resume Data 520 preferably extends backup Embedded Document Data 519.

According to a preferred embodiment of the present invention, Report Logbook preferably provides the functionality necessary to create required reports in a variety of formats by User, User Authorized Entities and System Administrator. Preferably, an authoritative entity, such as one who “signs off” on information, can also create reports including reports on compliance status and impending non-compliance by Users. As shown in FIG. 7 User 600 preferably Creates Reports 612 in the logbook. Create Reports 612 is preferably extended by Specialty Report 610 and Graphical Report 611. In addition, User 600 preferably prints report with Print Report 613. Authorized Entity 602 and System Administrator 603 preferably use Creates Reports 612, while System Administrator 603 preferably also Prints report. Authoritative Entity 604 preferably extends Signing Entity 605, Creates Reports and Print Report. Backup System 606 preferably creates report on system backup. As shown in FIG. 16A, reports may preferably be produced as specialty government reports or, as is shown in FIG. 16B preferably produced in graphical format. As shown in FIG. 16C reports may also preferably be produced for Users. This arrangement embodies herein selectively authorizing such at least one authoritative entity to search such logbook information relating to impending non-compliance. This arrangement embodies herein selectively authorizing such at least one authoritative entity to search such logbook information relating to at least such non-compliance.

According to a preferred embodiment of the present invention, system provides the capability to preferably record the results of the different required checks of the aircraft (Preflight, Before Starting Engine, After Starting Engine, etc.) in the logbook's electronic checklist facility as the pilot performs them. As shown in FIG. 8 the Manage Logbook Extensions for Other Cases preferably provides details specific to aviation that are not shown in FIG. 5. A pilot, aircraft mechanic, flight attendant or other person who would manage the activities or actions relating to an aviation-specific logbook, User 701, preferably extends user 700. User 700 can preferably have an Expense Log that may or may be tied to a Flight Entry. Add 710 and Update Logbook Entry 719 can preferably be extended by Assign Aircraft to Flight 711, Remove Aircraft to Flight 712, Weight & Balance 714, and Airplane Checklist 715. Add 710 and Update Logbook Entries 713 preferably use Authoritative Database 716. The FAA Database and other Government Databases 717 preferably extend the Authoritative Databases. User 700 can preferably create and track his/her complete expenses 716 relating to the logged flight. User 700 can preferably have the logbook entry extended or enhanced by having the aircraft with flight plans that would include specific weather conditions and are related to aircraft databases. The flight that is recorded can preferably have a Government approved Weight & Balance 714 also built and tied directly to it. This gives, for example, a pilot the capability to preferably use a wireless device to perform the required Weight & Balance 714 for a flight. The Weight & Balance 714 can preferably then be stored in a database that is directly tied to the Logbook Entry 710 or 713. The same can preferably be said for the Airplane Checklists 715 that must be performed by the pilot.

The Airplane Checklists 715 and Weight & Balance 714 data is preferably transmitted electronically via wireless devices and are stored in a database that can preferably be tied directly to the Flight Details 710 or 713. These processes, which have never been available before, give the pilot the ability to electronically file the Weight & Balance 714 and Airplane Checklists 715 and to store and tie them directly to the flight records. This further provides validated proof to outside entities (like the FAA, government entities, insurance companies, etc.) that a pilot has performed these actions. This arrangement embodies herein implementing inputting completion information related to at least one task of at least one checklist by such at least one user; implementing storing in such inputted completion information related to such at least one task of such at least one checklist; implementing selecting at least one set of such stored completion information related to such at least one task of such at least one checklist by such at least one user; and implementing displaying such at least one set of such completion information related to such at least one task of such at least one checklist. This arrangement embodies herein at least one computer interface system structured and arranged to input completion information related to at least one task of at least one by at least one such second user; at least one computer processor system structured and arranged to store in such unified database system such inputted completion information related to at least one such task of at least one such checklist; at least one computer processor system structured and arranged to select at least one set of such stored completion information related to at least one such task of at least one such checklist by at least one such second user; and at least one computer interface system structured and arranged to present at least one such set of such stored completion information related to at least one such task of at least one such checklist. This arrangement embodies herein computer-assisting inputting completion information related to at least one task of at least one checklist by at least one such second user; computer-assisting storing in such unified database system such inputted completion information related to at least one task of at least one checklist; computer-assisting selecting at least one set of such stored completion information related to at least one task of at least one checklist by at least one such second user; and computer-assisting presenting at least one such set of such stored completion information related to at least one task of at least one checklist. Preferably, this enhances the pilot's record keeping abilities while not requiring physical paperwork by the pilot. One skilled in the art will appreciate that these various use cases can be omitted, rearranged or adapted in various ways in appropriate circumstances and that the Manage Logbook Aviation Extensions can be applied into areas and fields beyond aviation.

According to a preferred embodiment of the present invention, the system preferably provides the capability to request and store electronic signatures, record the results of the approval and notifies the requestor of those results. As shown in FIG. 9 the process preferably begins by User 800 initiating a Signature Request 810. Preferably, the Signature Request gets handed off to the Logbook System 802 in the form of a Request to Notify 811. The Notification of the Request by the Logbook System 802 to the Authoritative Entity 801 is preferably in the form of a Request to Sign/Approve Logbook Entries 812. Authoritative Entity 801 will preferably then Sign the Logbook 813 or decline, Not Sign 814. Logbook System 802 then preferably Notifies 815 the Requesting User 800 of the decision of the Authoritative Entity 801. The Request is preferably then Closed 816. This arrangement embodies herein permitting requesting at least one electronic authorization signature from such at least one authoritative entity relating to such logbook information of such at least one user by such at least one user; permitting inputting such at least one electronic authorization signature relating to such logbook information of such at least one user by such at least one authoritative entity; and storing in such unified database system such at least one electronic authorization signature relating to such logbook information of such at least one user. This arrangement embodies herein at least one computer processor system structured and arranged to request at least one electronic authorization signature from at least one such second user relating to such individual logbook information of at least one such first user; and at least one computer interface system structured and arranged to input at least one such authorization signature relating to such individual logbook information of at least one such first user by at least one such second user; and wherein such at least one unified database system is structured and arranged to store electronic authorization signatures relating to such logbook information. This arrangement embodies herein computer-assisting requesting at least one electronic authorization signature from at least one such second user relating to such individual logbook information of at least one such first user; computer-assisting inputting at least one such authorization signature relating to such individual logbook information of at least one such first user by at least one such second user; and computer-assisting for storing in such unified database system electronic authorization signatures relating to such logbook information.

In a preferred embodiment of the present invention, the system preferably provides the methods for requesting and storing electronic endorsements, recording the results of the endorsement and notifying the requester of the results. As shown in FIG. 10 the process begins by Authoritative Entity 851 preferably initiating a Build Endorsement 860. The Build Endorsement is then preferably handed off to the Logbook System 852 in the form of a Notify of Decision 861. The Notify of Decision 861 by the Logbook System 852 is preferably then handed off to the User 850 in the form of a Notification (Alert) 862. The User 850 will then preferably Remove the Notification 864 or decline the notification. Preferably the Request is then Closed 865. As shown in FIGS. 25A-25C a wide variety of endorsements are preferably supported by the system. As shown in FIG. 28 the current endorsements for User (pilot) 850 by Authoritative Entity 851 are preferably available for display. This arrangement embodies herein permitting requesting at least one electronic endorsement signature from such at least one authoritative entity relating to such logbook information of such at least one user by such at least one user; permitting inputting such at least one electronic endorsement signature by such at least one authoritative entity relating to such logbook information of such at least one user; and storing in such unified database system such at least one electronic endorsement signature relating to such logbook information of such at least one user. This arrangement embodies herein at least one computer processor system structured and arranged to request at least one electronic endorsement signature relating to such individual logbook information of at least one such first user by at least one such second user; and at least one computer interface system structured and arranged to input at least one such electronic endorsement signature by at least one such second user relating to such individual logbook information of at least one such first user; wherein such at least one unified database system is structured and arranged to store at least one such electronic endorsement signature relating to such individual logbook information of at least one such first user. This arrangement embodies herein computer-assisting requesting at least one electronic endorsement signature relating to such individual logbook information of at least one such first user by at least one such second user; computer-assisting inputting at least one such electronic endorsement signature by at least one such second user relating to such individual logbook information of at least one such first user; and computer-assisting storing in such unified database system at least one such electronic endorsement signature relating to such individual logbook information of at least one such first user.

In a preferred embodiment of the present invention, the system provides a method for evaluating logbook entries and determining if the User is in compliance with rules set by an authoritative entity or if the User will not be in compliance at a future date, then preferably notifying either the user and/or the authoritative entity. As shown in FIG. 1 the process begins by System 5002 preferably initiating Alerts 5010. The Logbook System 5002 preferably determines if an Alerts condition exists. Preferably, when an Alert condition exists, Notify of Alert 5011 determines to whom, or to which entity, the alert is to be directed. The system also determines the type of alert. Preferably For User 5000 alerts, a Create User Alert 5012 is created. Similarly, if Authoritative Entity 5001 alert exists, then a Create User Alert 5013 is preferably created. Finally, if the alert is a System 5002 then a Create System Alert 5014 is preferably created. Upon creation of alerts 5013, 5014, or 5015, the corresponding Close Alert 5016, 5017, or 5018 preferably closes the alert. This arrangement embodies herein permitting storing in such at least one unified database of at least one requirement for compliance set by such at least one authoritative entity for such at least one user; and defining which such at least one authoritative entity is responsible for such setting at least one requirement for compliance for such at least one user. This arrangement embodies herein identifying potential impending non-compliance with such at least one requirement for compliance by such at least one user; notifying such at least one user of such impending non-compliance with such at least one requirement for compliance; and notifying such at least one authoritative entity of such impending non-compliance with such at least one requirement for compliance for such at least one user. This arrangement embodies herein identifying non-compliance with such at least one requirement for compliance by such at least one user; notifying such at least one user of such non-compliance with such at least one requirement for compliance; and notifying at least authoritative entity of such non-compliance with such at least one requirement for compliance for such at least one user. This arrangement embodies herein at least one computer interface system structured and arranged to set at least one requirement for compliance for at least one such first user by at least one such second user; at least computer processor system structured and arranged to identify impending non-compliance with at least one such requirement for compliance by at least one such first user as set by at least one such second user; and at least one computer processor system structured and arranged to notify at least one such first user of their impending non-compliance with at least one such requirement for compliance. This arrangement embodies herein at least one computer processor system structured and arranged to identify non-compliance with at least one such requirement for compliance as set by at least one such first user; and at least one computer processor system structured and arranged to notify at least one such first user of their non-compliance with at least one such requirement for compliance. This arrangement embodies herein computer-assisting setting at least one requirement for compliance for at least one such first user by at least one such second user; computer-assisting identifying impending non-compliance with at least one such requirement for compliance by at least one such first user as set by at least one such second user; and computer-assisting notifying at least one such first user of their impending non-compliance with at least one such requirement for compliance. This arrangement embodies herein computer-assisting identifying non-compliance with at least one such requirement for compliance as set by at least one such first user; and computer-assisting notifying at least one such first user of their non-compliance with at least one such requirement for compliance. This arrangement embodies herein at least one computer processor system structured and arranged to notify at least one such second user of impending non-compliance with at least one such particular requirement for compliance for at least one such first user. This arrangement embodies herein at least one computer processor system structured and arranged to notify at least one such second user of non-compliance with at least one such particular requirement for compliance for at least one such first user. This arrangement embodies herein computer-assisting notifying at least one such second user of impending non-compliance with at least one such particular requirement for compliance for at least one such first user. This arrangement embodies herein computer-assisting notifying at least one such second user of non-compliance with at least one such particular requirement for compliance for at least one such first user.

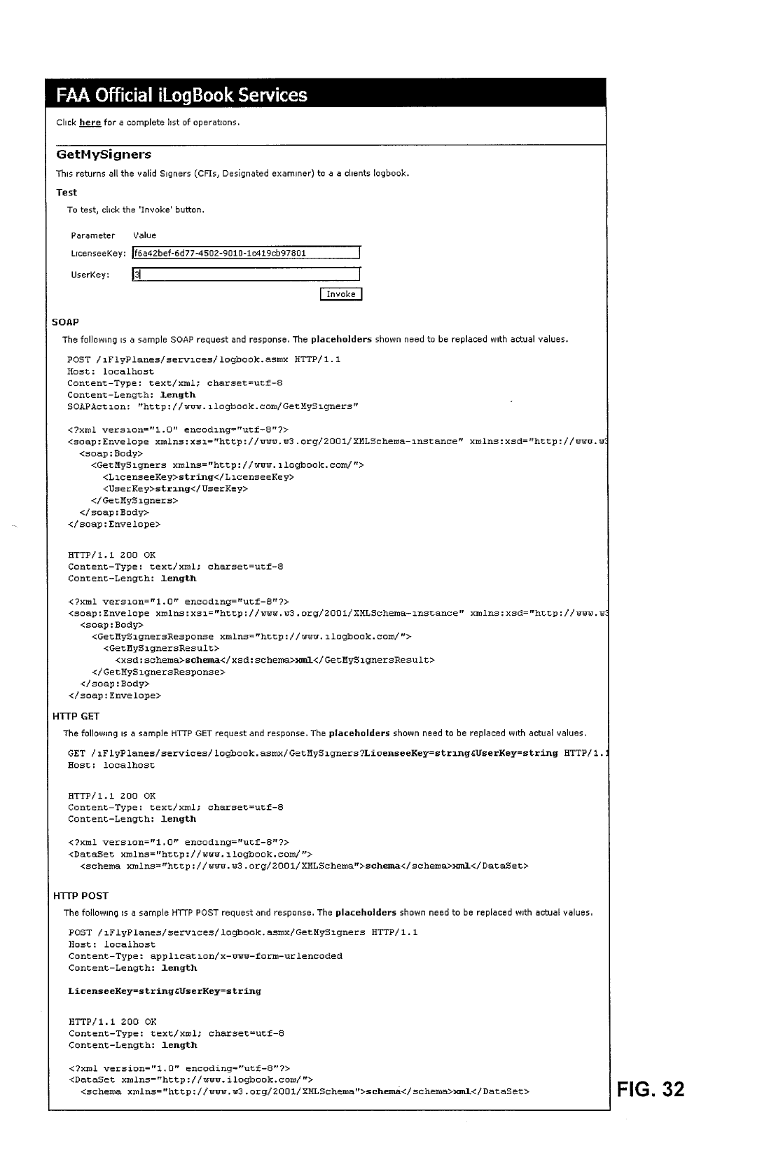

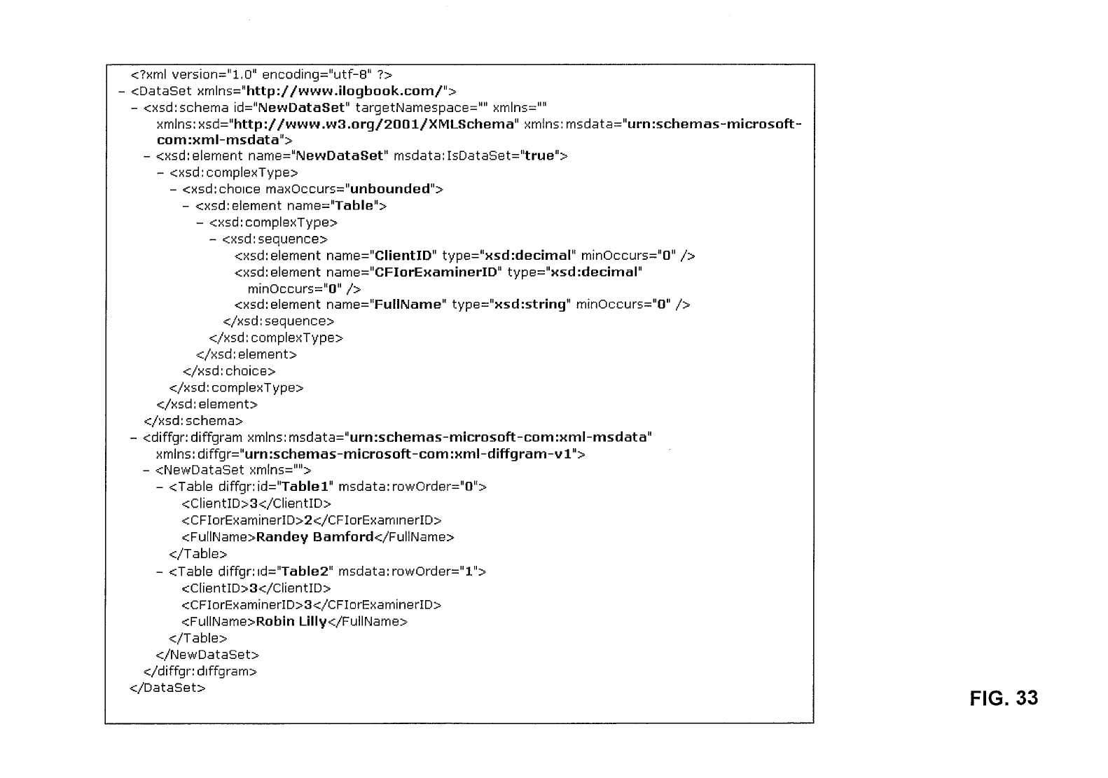

In a preferred embodiment of the present invention, the functionality of the system is preferably delivered using a web service via SOAP interface. Preferably, this allows the functionality of the logbook system to be distributed on a WAN/LAN and allows the user of the system to preferably build a personalized interface to the system and preferably eliminate the need to rely on the user interface as distributed with the system. Preferably, this allows the customer to build the user interface and thus rely on the logbook system to control the data. This arrangement embodies herein permitting modification of at least one user interface screen by such at least one user to meet personal requirements of such at least one user. This arrangement embodies herein at least one computer interface system structured and arranged to permit modification of at least one user interface screen by such at least one user meet personal requirements of such at least one user. This arrangement embodies herein computer-assisting modification of at least one user interface screen by such at least one user meet personal requirements of such at least one user. As shown in FIG. 31 the functions that are preferably available as listed. As shown in FIG. 32 the function GetMySigners, which returns all valid electronic signatories of the logbook, preferably generates a set of SOAP code to complete the request. The code is shown here for illustrative purposes and is preferably not exposed to the user. As shown in FIG. 33 the GetMySigners request shown in FIG. 32 preferably causes an XML result set to be generated that will display the requested information to the user.

Although applicant has described applicant's preferred embodiments of this invention, it will be understood that the broadest scope of this invention includes such modifications as diverse shapes, sizes and materials. Such scope is limited only by the below claims as read in connection with the above specification. Further, many other advantages of applicant's invention will be apparent to those skilled in the art from the above descriptions and the below claims.

What is claimed is:

1) An Internet system, for the unified collection of required logbook information, comprising the steps of:
a) permitting substantially all users of at least one population of such users in at least one specified regulated area of at least one specified geo-political area, from respective user-input stations, to input respective data packets relating to such required logbook information to at least one Internet server; and
b) storing of such inputted required logbook information in at least one unified database system.

2) The Internet system according to claim 1, further comprising:
a) permitting at least one authoritative entity, related to such at least one specified regulated area of such at least one specified geo-political area, at least partial access to such stored required logbook information.

3) The Internet system according to claim 2, further comprising:
a) permitting storing in such at least one unified database of at least one requirement for compliance set by such at least one authoritative entity for such at least one user; and
b) defining which such at least one authoritative entity is responsible for such setting at least one requirement for compliance for such at least one user.

4) The Internet system according to claim 3, further comprising:
a) identifying potential impending non-compliance with such at least one requirement for compliance by such at least one user;
b) notifying such at least one user of such impending non-compliance with such at least one requirement for compliance; and
c) notifying such at least one authoritative entity of such impending non-compliance with such at least one requirement for compliance for such at least one user.

5) The Internet system according to claim 4 further comprising the step of:
a) selectively authorizing such at least one authoritative entity to search such logbook information relating to impending non-compliance.

6) The Internet system according to claim 3, further comprising:
a) identifying non-compliance with such at least one requirement for compliance by such at least one user;
b) notifying such at least one user of such non-compliance with such at least one requirement for compliance; and
c) notifying at least one authoritative entity of such non-compliance with such at least one requirement for compliance for such at least one user.

7) The Internet method according to claim 6 further comprising the steps of:
a) selectively authorizing such at least one authoritative entity to search such logbook information relating to at least such non-compliance.

8) The Internet system according to claim 2, further comprising:
a) permitting requesting at least one electronic authorization signature from such at least one authoritative entity relating to such logbook information of such at least one user by such at least one user;
b) permitting inputting such at least one electronic authorization signature relating to such logbook information of such at least one user by such at least one authoritative entity; and
c) storing in such unified database system such at least one electronic authorization signature relating to such logbook information of such at least one user.

9) The Internet system according to claim 2, further comprising:
a) permitting requesting at least one electronic endorsement signature from such at least one authoritative entity relating to such logbook information of such at least one user by such at least one user;
b) permitting inputting such at least one electronic endorsement signature by such at least one authoritative entity relating to such logbook information of such at least one user; and
c) storing in such unified database system such at least one electronic endorsement signature relating to such logbook information of such at least one user.

10) The Internet system according to claim 2 further comprising:
a) permitting selective authorization, by such at least one authoritative entity, for such at least one user, from respective client stations, to send selective information relating to such logbook information to such at least one Internet server; and
b) permitting access by such at least one user to such selective information.

11) The Internet system according to claim 10 further comprising:
a) permitting such at least one user to select at least one search criterion for the selection of information; and
b) permitting such at least one user to view such information that meets such at least one criterion.

12) The Internet system according to claim 10 further comprising:
a) permitting embedding of such logbook information directly into other electronic documents where all combined document details, both those from such logbook information and such other original documents, can be analyzed.

13) The Internet system according to claim 2, further comprising:
a) permitting such at least one user, from respective user-input stations, to send respective data packets relating to respective demographic information to an Internet server; and
b) storing in such unified database system such demographic information relating to such logbook information of such at least one user.

14) The Internet system according to claim 2, further comprising:
a) permitting such at least one authoritative entity, from respective client stations, to send respective data packets relating to respective biomedical identification information for such at least one user to such at least one Internet server; and
b) storing in such unified database system such biomedical identification information relating to such logbook information of such at least one user.

15) The Internet system according to claim 2, further comprising:
a) permitting such at least one authoritative entity, from respective client stations, to send respective data packets relating to respective medical information for such at least one user to such at least one Internet server; and
b) storing in such unified database system such medical information relating to such logbook information of such at least one user.

16) The Internet system according to claim 2 further comprising:
a) implementing accessing other databases containing information related to such logbook information.

17) The Internet system according to claim 2 further comprising:
a) implementing inputting such logbook information using at least one stand-alone device;
b) implementing storing such inputted logbook information on such at least one stand-alone device;
c) implementing transmitting such stored logbook information from such at least one stand-alone device to at least one wide area network; and
d) implementing storing such transmitted logbook information in such unified database system.

18) The Internet system according to claim 17 further comprising:
a) implementing transmitting such logbook information of such at least one user to such at least one stand-alone device from such at least one wide area network;
b) implementing storing such logbook information on such at least one stand-alone device; and
c) implementing displaying such logbook information stored on such at least one stand-alone device to such at least one user.

19) The Internet system according to claim 2 further comprising:
a) implementing inputting such logbook information on at least one wireless device;
b) implementing storing such inputted logbook information on such at least one wireless device;
c) implementing transmitting such stored logbook information from such at least one wireless device to at least one wide area network; and
d) implementing storing such transmitted logbook information in such unified database system.

20) The Internet system according to claim 19 further comprising:
a) implementing transmitting such logbook information of such at least one user to such at least one wireless device from such at least one wide area network;
b) implementing storing such logbook information on such at least one wireless device; and
c) implementing displaying such logbook information stored on such at least one wireless device to such at least one user.

21) The Internet system according to claim 2 further comprising:
a) implementing inputting completion information related to at least one task of at least one checklist by such at least one user;
b) implementing storing in such inputted completion information related to such at least one task of such at least one checklist;
c) implementing selecting at least one set of such stored completion information related to such at least one task of such at least one checklist by such at least one user; and
d) implementing displaying such at least one set of such completion information related to such at least one task of such at least one checklist.

22) The Internet system according to claim 21 wherein such at least one checklist, further comprises:
a) at least one equipment checklist;
b) at least one equipment pre-use checklist;
c) at least one equipment in-use checklist; and
d) at least one equipment post-use checklist.

23) The Internet system according to claim 2, further comprising:
a) permitting modification of at least one user interface screen by such at least one user to meet personal requirements of such at least one user.

24) An Internet website client-server computer system comprising:
a) at least one computer interface system structured and arranged to assist input of individual logbook information on behalf of at least one first user of a population of first users;
b) at least one unified database system structured and arranged to store said individual logbook information;
c) at least one computer processor system structured and arranged to assist accessing of said individual logbook information by at least one second user; and
d) at least one computer processor system structured and arranged to assist accessing of said individual logbook information by said at least one first user of said population of first users.

25) The Internet website client-server computer system according to claim 24, further comprising:
a) at least one computer processor structured and arranged to retrieve at least one outside record relating to said individual logbook information.

26) The Internet website client-server computer system according to claim 24, further comprising:
a) at least one computer interface system structured and arranged to selectively control access to said individual logbook information by said at least one second user;
b) at least one computer interface system structured and arranged to selectively grant access privileges to said at least one second user; and
c) at least computer processor system structured and arranged to selectively restrict said access privileges of said at least one second user to at least one particular portion of said individual logbook information.

27) The Internet website client-server computer system according to claim 24, further comprising:
a) at least one computer interface system structured and arranged to set at least one requirement for compliance for at least one said first user by at least one said second user;
b) at least computer processor system structured and arranged to identify impending non-compliance with at least one said requirement for compliance by at least one said first user as set by at least one said second user; and
c) at least one computer processor system structured and arranged to notify at least one said first user of their impending non-compliance with at least one said requirement for compliance.

28) The Internet website client-server computer system according to claim 27, further comprising:
a) at least one computer processor system structured and arranged to notify at least one said second user of impending non-compliance with at least one said particular requirement for compliance for at least one said first user.

29) The Internet website client-server computer system according to claim 27, further comprising:
a) at least one computer processor system structured and arranged to identify non-compliance with at least one said requirement for compliance as set by at least one said first user; and
b) at least one computer processor system structured and arranged to notify at least one said first user of their non-compliance with at least one said requirement for compliance.

30) The Internet website client-server computer system according to claim 29, further comprising:
a) at least one computer processor system structured and arranged to notify at least one said second user of non-compliance with at least one said particular requirement for compliance for at least one said first user.

31) The Internet website client-server computer system according to claim 24, further comprising:
a) at least one computer processor system structured and arranged to request at least one electronic authorization signature from at least one said second user relating to said individual logbook information of at least one said first user; and
b) at least one computer interface system structured and arranged to input at least one said authorization signature relating to said individual logbook information of at least one said first user by at least one said second user; and
c) wherein said at least one unified database system is structured and arranged to store electronic authorization signatures relating to said logbook information.

32) The Internet website client-server computer system according to claim 24, further comprising:
a) at least one computer processor system structured and arranged to request at least one electronic endorsement signature relating to said individual logbook information of at least one said first user by at least one said second user; and
b) at least one computer interface system structured and arranged to nput at least one said electronic endorsement signature by at least one said second user relating to said individual logbook information of at least one said first user;
c) wherein said at least one unified database system is structured and arranged to store at least one said electronic endorsement signature relating to said individual logbook information of at least one said first user.

33) The Internet website client-server computer system according to claim 24, further comprising:
a) at least one computer interface system structured and arranged to set the selection criteria by at least one said second user from said individual logbook information;
b) at least one computer processor system structured and arranged to select a set of said individual logbook information; and
c) at least one computer interface system structured and arranged to present at least one said set of said individual logbook information for viewing by at least one said second user.

34) The Internet website client-server computer system according to claim 24, wherein said computer interface system for assisting input of individual logbook information on behalf of at least one first user of a population of first users further comprises:
a) at least one computer interface system structured and arranged to input said individual logbook information using at least one stand-alone device;
b) at least one computer processor system structured and arranged to store such inputted said individual logbook information on said at least one stand-alone device; and
c) at least one computer transmitter system structured and arranged to transmit said individual logbook information from at least one said stand-alone device to said unified database system.

35) The Internet website client-server computer system according to claim 34, further comprising:
a) at least one computer transmitter system structured and arranged to transmit said individual logbook information from at least one said unified database system to at least one said stand-alone device;
b) at least one computer processor system for storing said transmitted said logbook information on said at least one stand-alone device; and
c) at least one computer interface system structured and arranged to present at least one said set of said individual logbook information using at least one stand-alone device for viewing by at least one said second user.

36) The Internet website client-server computer system according to claim 24, wherein said computer interface system structured and arranged for assisting input of individual logbook information on behalf of at least one first user of a population of first users further comprises:
a) at least one computer interface system structured and arranged to input said individual logbook information using at least one wireless device;
b) at least one computer processor system structured and arranged to store such inputted said individual logbook information on said wireless device; and
c) at least one computer transmitter system structured and arranged to transmit said stored individual logbook information from at least one said wireless device to said unified database system.

37) The Internet website client-server computer system according to claim 36, further comprising:
a) at least one computer transmitter system structured and arranged to transmit said individual logbook information from at least one said unified database system to at least one said wireless device;
b) at least one computer processor system for storing said transmitted logbook information on said at least one wireless device; and
c) at least one computer interface system structured and arranged to present at least one said set of said stored individual logbook information using at least one wireless device for viewing by at least one said second user.

38) The Internet website client-server computer system according to claim 24, further comprising:
a) at least one computer interface system structured and arranged to input completion information related to at least one task of at least one by at least one said second user;
b) at least one computer processor system structured and arranged to store in said unified database system said inputted completion information related to at least one said task of at least one said checklist;
c) at least one computer processor system structured and arranged to select at least one set of said stored completion information related to at least one said task of at least one said checklist by at least one said second user; and
d) at least one computer interface system structured and arranged to present at least one said set of said stored completion information related to at least one said task of at least one said checklist.

39) The Internet website client-server computer system according to claim 38 wherein said at least one checklist, further comprises:
a) at least one equipment checklist;
b) at least one equipment pre-use checklist;
c) at least one equipment in-use checklist; and
d) at least one equipment post-use checklist.

40) The Internet website client-server computer system according to claim 24, further comprising:
a) at least one computer processor system structured and arranged to combine said individual logbook information directly with other electronic documents to form a combined document;
b) at least one computer processor system structured and arranged to analyze at least one said combined document details; and
c) at least one computer interface system structured and arranged to present results of said analysis to at least one said second user.

41) The system according to claim 24, further comprising:
a) at least one computer interface system structured and arranged to permit modification of at least one user interface screen by such at least one user meet personal requirements of such at least one user.

42) An Internet website client-server computer system comprising:
a) computer-assisting input of individual logbook information on behalf of at least one first user of a population of first users;
b) computer-assisting storing in such at least one unified database system such individual logbook information;
c) computer-assisting accessing of said individual logbook information by at least one second user; and
d) computer-assisting accessing of said individual logbook information by said at least one first user of said population of first users.

43) The system according to claim 42, further comprising:
a) computer-assisting retrieval of at least one outside record relating to said individual logbook information.

44) The system according to claim 42, further comprising:
a) computer-assisting selectively controlling access to said individual logbook information by said at least one second user;
b) computer-assisting selectively granting access privileges to said at least one second user; and
c) computer-assisting selectively restricting said access privileges of said at least one second user to at least one particular portion of said individual logbook information.

45) The system according to claim 42, further comprising:
a) computer-assisting setting at least one requirement for compliance for at least one said first user by at least one said second user;
b) computer-assisting identifying impending non-compliance with at least one said requirement for compliance by at least one said first user as set by at least one said second user; and
c) computer-assisting notifying at least one said first user of their impending non-compliance with at least one said requirement for compliance.

46) The system according to claim 45, further comprising:
a) computer-assisting notifying at least one said second user of impending non-compliance with at least one said particular requirement for compliance for at least one said first user.

47) The system according to claim 45, further comprising:
a) computer-assisting identifying non-compliance with at least one said requirement for compliance as set by at least one said first user; and
b) computer-assisting notifying at least one said first user of their non-compliance with at least one said requirement for compliance.

48) The system according to claim 47, further comprising:
a) computer-assisting notifying at least one said second user of non-compliance with at least one said particular requirement for compliance for at least one said first user.

49) The system according to claim 42, further comprising:
a) computer-assisting requesting at least one electronic authorization signature from at least one said second user relating to said individual logbook information of at least one said first user;
b) computer-assisting inputting at least one said authorization signature relating to said individual logbook information of at least one said first user by at least one said second user; and
c) computer-assisting for storing in said unified database system electronic authorization signatures relating to said logbook information.

50) The system according to claim 42, further comprising:
a) computer-assisting requesting at least one electronic endorsement signature relating to said individual logbook information of at least one said first user by at least one said second user;
b) computer-assisting inputting at least one said electronic endorsement signature by at least one said second user relating to said individual logbook information of at least one said first user; and
c) computer-assisting storing in said unified database system at least one said electronic endorsement signature relating to said individual logbook information of at least one said first user.

51) The system according to claim 42, further comprising:
a) computer-assisting setting the selection criteria by at least one said second user from said individual logbook information;
b) computer-assisting selecting a set of said individual logbook information; and
c) computer-assisting presenting a at least one said set of said individual logbook information for viewing by at least one said second user.

52) The system according to claim 42, wherein said computer interface system is structured and arranged to assist input of individual logbook information on behalf of at least one first user of a population of first users further comprises:
a) computer-assisting inputting said individual logbook information using at least one stand-alone device;
b) computer-assisting storing said inputted individual logbook information on said at least one stand-alone device; and
c) computer-assisting transmitting said stored individual logbook information from at least one said stand-alone device to said unified database system.

53) The system according to claim 52, further comprising:
a) computer-assisting transmitting said individual logbook information from at least one said unified database system to at least one said stand-alone device;
b) computer-assisting storing said transmitted said logbook information on said at least one stand-alone device; and
c) computer-assisting presenting at least one said set of stored individual logbook information using at least one said stand-alone device for viewing by at least one said second user.

54) The system according to claim 42, wherein said computer-assisting input of individual logbook information on behalf of at least one first user of a population of first users further comprises:
a) computer-assisting inputting said individual logbook information using at least one wireless device;
b) computer-assisting storing said inputted individual logbook information on said wireless device; and
c) computer-assisting transmitting said stored individual logbook information from at least one said wireless device to said unified database system.

55) The system according to claim 54, further comprising:
a) computer-assisting transmitting said individual logbook information from at least one said unified database system to at least one said wireless device;
b) computer-assisting storing said transmitted said logbook information on said at least one wireless device; and
c) computer-assisting presenting at least one said set of said individual logbook information using at least one wireless device for viewing by at least one said second user.

56) The system according to claim 42, further comprising:
a) computer-assisting inputting completion information related to at least one task of at least one checklist by at least one said second user;
b) computer-assisting storing in said unified database system said inputted completion information related to at least one task of at least one checklist;
c) computer-assisting selecting at least one set of said stored completion information related to at least one task of at least one checklist by at least one said second user; and
d) computer-assisting presenting at least one said set of said stored completion information related to at least one task of at least one checklist.

57) The system according to claim 56 wherein said at least one checklist, further comprises:
a) at least one equipment checklist;
b) at least one pre-use equipment checklist;
c) at least one in-use equipment checklist; and
d) at least one post-use equipment checklist.

58) The system according to claim 42, further comprising:
a) computer-assisting combining said individual logbook information directly with other electronic documents to form a combined document;
b) computer-assisting analyzing at least one said combined document details; and
c) computer-assisting presenting results of said analyzing to at least one said second user.

59) The system according to claim 42, further comprising:
a) computer-assisting modification of at least one user interface screen by such at least one user meet personal requirements of such at least one user.

60) An Internet website client-server computer system comprising:
a) at least one computer interface system structured and arranged to assist input of individual logbook information on behalf of at least one user of a population of users;
b) at least one unified database system structured and arranged to store said individual logbook information;
c) at least one computer processor system structured and arranged to assist accessing of said individual logbook information by at least one authoritative entity;
d) at least one computer processor system structured and arranged to assist accessing of said individual logbook information by said at least one user of said population of users;
e) at least one computer interface system structured and arranged to selectively control access to said individual logbook information by said at least one authoritative entity;
f) at least one computer interface system structured and arranged to selectively grant access privileges to said at least one authoritative entity;
g) at least one computer processor system structured and arranged to selectively restrict said access privileges of said at least one authoritative entity to at least one particular portion of said individual logbook information;
h) at least one computer interface system structured and arranged to set at least one requirement for compliance for at least one said user by at least one said authoritative entity;
i) at least one computer processor system structured and arranged to identify impending non-compliance with at least one said requirement for compliance by at least one said user as set by at least one said authoritative entity;
j) at least one computer processor system structured and arranged to notify at least one said user of their impending non-compliance with at least one said requirement for compliance;
k) at least one computer processor system structured and arranged to request at least one electronic authorization signature from at least one said authoritative entity relating to said individual logbook information of at least one said user;
l) at least one computer interface system structured and arranged to input at least one said electronic authorization signature relating to said individual logbook information of at least one said user by at least one said authoritative entity;
m) at least one unified database system management system structured and arranged to store electronic authorization signatures relating to said logbook information;
n) at least one computer interface system structured and arranged to set the selection criteria by at least one said authoritative entity from said individual logbook information;
o) at least one computer processor system structured and arranged to select a set of said individual logbook information; and
p) at least one computer interface system structured and arranged to present at least one said set of said individual logbook information for viewing by at least one said authoritative entity.

61) The system according to claim 60 further comprising:
a) at least one computer processor system structured and arranged to retrieve at least one outside record relating to said individual logbook information;
b) at least one computer processor system structured and arranged to notify at least one said authoritative entity of impending non-compliance with at least one said particular requirement for compliance for at least one said user;
c) at least one computer processor system structured and arranged to identify non-compliance with at least one said requirement for compliance as set by at least one said user;
d) at least one computer processor system structured and arranged to notify at least one said user of their non-compliance with at least one said requirement for compliance;
e) at least one computer processor system structured and arranged to notify at least one said authoritative entity of non-compliance with at least one said particular requirement for compliance for at least one said user;
f) at least one computer processor system structured and arranged to request at least one electronic endorsement signature relating to said individual logbook information of at least one said user by at least one said authoritative entity;
g) at least one computer interface system structured and arranged to input at least one said electronic endorsement signature by at least one said authoritative entity relating to said individual logbook information of at least one said user;
h) at least one unified database system structured and arranged to store at least one said electronic endorsement signature relating to said individual logbook information of at least one said user;
i) at least one computer processor system structured and arranged to combine said individual logbook information directly with other electronic documents to form a combined document;
j) at least one computer processor system structured and arranged to analyze at least one said combined document details;
k) at least one computer interface system structured and arranged to present results of said analysis to at least one said authoritative entity; and
l) at least one computer interface system permitting modification of at least one user interface screen by such at least one user meet personal requirements of such at least one user.

62) The system according to claim 60, wherein said computer interface system structured and arranged to assist input of individual logbook information on behalf of at least one user of a population of users further comprises:
a) at least one computer interface system structured and arranged to input said individual logbook information using at least one stand-alone device;
b) at least one computer processor system structured and arranged to store said inputted said individual logbook information on at least one said stand-alone device;
c) at least one computer transmitter system structured and arranged to transmit said individual logbook information from at least one said stand-alone device to said unified database system;
d) at least one computer transmitter system structured and arranged to transmit said individual logbook information from at least one said unified database system to at least one said stand-alone device;
e) at least one computer interface system structured and arranged to present at least one said set of said individual logbook information using at least one said stand-alone device for viewing by at least one said authoritative entity;
f) at least one computer interface system structured and arranged to input said individual logbook information using at least one said wireless device;
g) at least one computer processor system structured and arranged to store said inputted said individual logbook information on at least one said wireless device; and
h) at least one computer transmitter system structured and arranged to transmit said individual logbook information from at least one said wireless device to at least one said unified database system;
i) at least one computer transmitter system structured and arranged to transmit said individual logbook information from at least one said unified database system to at least one said wireless device; and
j) at least one computer interface system structured and arranged to present at least one said set of said individual logbook information using at least one said wireless device for viewing by at least one said authoritative entity.

63) The system according to claim 60, further comprising:
a) at least one computer interface system structured and arranged to input completion information related to at least one task of at least one checklist by at least one said authoritative entity;
b) at least one computer processor system structured and arranged to store in a unified database system said inputted completion information related to at least one said task of at least one said checklist;
c) at least one computer processor system structured and arranged to select at least one set of said stored completion information related to at least one said task of at least one said checklist by at least one said authoritative entity; and
d) at least one computer interface system structured and arranged to present at least one said set of said stored completion information related to at least one said task of at least one said checklist;
e) wherein said at least one checklist comprises
i) at least one equipment checklist,
ii) at least one equipment pre-use checklist,
iii) at least one equipment in-use checklist, and
iv) at least one equipment post-use checklist.

64) An Internet website client-server computer system according to claim 24 in which:
a) the logbook information is associated with aviation;
b) the information managed is associated with pilots of any type of aircraft; and
c) the logbook information is associated with logbooks of pilots of any type of aircraft.

65) An Internet website client-server computer system according to claim 24 in which:
a) the logbook information is associated with water-borne shipping;
b) the logbook information is associated with ships; and
c) the logbook information is associated with logbooks of ships.

66) An Internet website client-server computer system according to claim 24 in which:
a) the logbook information is associated with interstate trucking;
b) the logbook information is associated with truck drivers; and
c) the logbook information is associated with logbooks of truck drivers.

67) An Internet website client-server computer system according to claim 24 in which:
a) the logbook information is associated with SCUBA divers; and
b) the logbook information is associate with logbooks of SCUBA divers.

68) An Internet website client-server computer system according to claim 42 in which:
a) the logbook information is associated with aviation;
b) the information managed is associated with pilots of any type of aircraft; and
c) the logbook information is associated with logbooks of pilots of any type of aircraft.

69) An Internet website client-server computer system according to claim 42 in which:
a) the logbook information is associated with water-borne shipping;
b) the logbook information is associated with ships; and
c) the logbook information is associated with logbooks of ships.

70) An Internet website client-server computer system according to claim 42 in which:
a) the logbook information is associated with interstate trucking;
b) the logbook information is associated with truck drivers; and
c) the logbook information is associated with logbooks of truck drivers.

71) An Internet website client-server computer system according to claim 42 in which:
a) the logbook information is associated with SCUBA divers; and
b) the logbook information is associate with logbooks of SCUBA divers.

72) An Internet website client-server computer system according to claim 60 in which:
a) the logbook information is associated with aviation;
b) the information managed is associated with pilots of any type of aircraft; and
c) the logbook information is associated with logbooks of pilots of any type of aircraft.

73) An Internet website client-server computer system according to claim 60 in which:
a) the logbook information is associated with water-borne shipping;
b) the logbook information is associated with ships; and
c) the logbook information is associated with logbooks of ships.

74) An Internet website client-server computer system according to claim 60 in which:
a) the logbook information is associated with interstate trucking;
b) the logbook information is associated with truck drivers; and
c) the logbook information is associated with logbooks of truck drivers.

75) An Internet website client-server computer system according to claim 60 in which:
a) the logbook information is associated with SCUBA divers; and
b) the logbook information is associate with logbooks of SCUBA divers.

76) An Internet website client-server computer system according to claim 60 in which:
a) the logbook information is associated with SCUBA divers; and
b) the logbook information is associate with logbooks of SCUBA divers.

77) An Internet website client-server computer system according to claim 1 in which:
a) the logbook information is associated with aviation;
b) the information managed is associated with pilots of any type of aircraft; and
c) the logbook information is associated with logbooks of pilots of any type of aircraft.

78) An Internet website client-server computer system according to claim 1 in which:
a) the logbook information is associated with water-borne shipping;
b) the logbook information is associated with ships; and
c) the logbook information is associated with logbooks of ships .

79) An Internet website client-server computer system according to claim 1 in which:
a) the logbook information is associated with interstate trucking;
b) the logbook information is associated with truck drivers; and
c) the logbook information is associated with logbooks of truck drivers.
